(19) United States
(12) Patent Application Publication
(10) Pub. No.: US 2017/0337573 A1
(43) Pub. Date: Nov. 23, 2017

(54) VEHICLE MANAGEMENT SERVICES

(71) Applicant: CarMoxy Inc., Beverly Hills, CA (US)

(72) Inventors: Jesse Cuneyt Toprak, Encino, CA (US); Mark Melnykowycz, Winterthur (CH)

(21) Appl. No.: 15/601,561

(22) Filed: May 22, 2017

Related U.S. Application Data
(60) Provisional application No. 62/339,395, filed on May 20, 2016.

(51) Int. Cl. G06Q 30/02; G06Q 40/02; G06Q 30/06; G07C 5/08

(52) U.S. Cl. CPC G06Q 30/0206; G07C 5/085; G06Q 40/025; G06Q 30/0202; G06Q 30/0282; G06Q 30/0643

(57) ABSTRACT

Systems, methods, and computer-readable media for a vehicle management service are provided.

### CROSS-REFERENCE TO RELATED APPLICATION(S)

This application claims the benefit of prior filed U.S. Provisional Patent Application No. 62/339,395, filed May 20, 2016, which is hereby incorporated by reference herein in its entirety.

### TECHNICAL FIELD

This disclosure relates to vehicle management services.

### BACKGROUND OF THE DISCLOSURE

Conventional transactions between vehicle sellers and vehicle buyers have several disadvantages including, but not limited to, inefficient networking between potential parties to a vehicle transaction, inability to foster trust in the health of a vehicle, and/or inability to facilitate identification of a fair market price for a vehicle.

### SUMMARY OF THE DISCLOSURE

This document describes systems, methods, and computer-readable media for a vehicle management service.

As an example, a system for managing a vehicle including at least one control unit may include a user subsystem communicatively coupled to the at least one control unit and operative to collect diagnostic data from at least one control module of the vehicle, and a service subsystem communicatively coupled to the user subsystem and operative to receive at least a portion of the diagnostic data from the user subsystem, determine the health of the vehicle based on the at least a portion of the diagnostic data, and use the determined health of the vehicle to facilitate at least one of maintenance of the vehicle and transfer of the ownership of the vehicle.

As another example, a method for managing a vehicle may include collecting diagnostic data from at least one control module of the vehicle, determining the health of the vehicle based on the collected diagnostic data, and using the determined health of the vehicle to facilitate at least one of maintenance of the vehicle and transfer of the ownership of the vehicle.

As yet another example, a non-transitory computer-readable storage medium may store at least one program, the at least one program including instructions, which when executed by an electronic device, cause the electronic device to collect diagnostic data from at least one control module of a vehicle, determine the health of the vehicle based on the collected diagnostic data, and use the determined health of the vehicle to facilitate at least one of maintenance of the vehicle and transfer of the ownership of the vehicle.

This Summary is provided only to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide a vehicle management service of the disclosure;

FIG. 1A is a more detailed schematic view of a subsystem of the system of FIG. 1;

FIG. 1B is a more detailed schematic view of a portion of the system of FIG. 1;

FIG. 1C is a more detailed schematic view of another portion of the system of FIG. 1;

FIG. 2 is a schematic showing relevant features of the vehicle management service for enhancing various phases of vehicle ownership;

FIGS. 3 and 4 are diagrams of potential integration between different products of the vehicle management service for connecting user behaviors to the maintenance and transaction aspects of vehicle ownership;

FIG. 5 is a diagram illustrating a scheme by which a vehicle health score may be calculated based on vehicle diagnostic data and maintenance history, which may then be used by different products of the vehicle management service for enhancing various phases of vehicle ownership;

FIG. 6 is a diagram illustrating how a vehicle commerce management product of the vehicle management service may utilize user data to generate vehicle commerce alerts and actions for enhancing various phases of vehicle ownership;

FIGS. 7-16, 17, 17A, 18-35 are screen shots of various illustrative user interfaces that may be provided by any suitable subsystem for any suitable user of the vehicle management service of the disclosure;

FIGS. 36-39 are schematics showing various variables that may be used to make various recommendations for the vehicle management service of the disclosure:

FIGS. 40-43, 44A, 44B, 44C, 45 are diagrams showing various functionalities of the vehicle management service of the disclosure; and

FIG. 46 is a flowchart of an illustrative process that may provide features of the vehicle management service of the disclosure.

### DETAILED DESCRIPTION OF THE DISCLOSURE

A vehicle management service is provided that may be operative to manage and enhance the vehicle ownership process for vehicle buyers, vehicle users, and vehicle sellers for enabling effective and efficient vehicle transactions. Vehicle on-board diagnostic data indicative of the status of any suitable vehicle subsystems (e.g., thousands of data points indicative of the current status and past use of a vehicle) may be collected by a vehicle management service platform and used in conjunction with any other suitable data that may be obtained about the vehicle (e.g., accident history, maintenance events, financial information, and/or the like that may be sensed by sensors of an on-vehicle user subsystem of the platform or collected from a user of such a subsystem or otherwise) to calculate a vehicle health score or CarScore that may be a verified and realistic indication of the current condition and health of the vehicle. This score may be utilized by the vehicle management service platform to allow for easy assessment of the true value of the vehicle, giving an easier method for buyers to purchase used vehicles with confidence in the condition of the vehicle. This score may also reduce the difficulties a person may have in assessing the value of their vehicle, ensuring they are in the best position to buy a new vehicle as their needs change. The score may also be used to inform a user of a vehicle how to properly treat the vehicle to maintain the health of the vehicle.

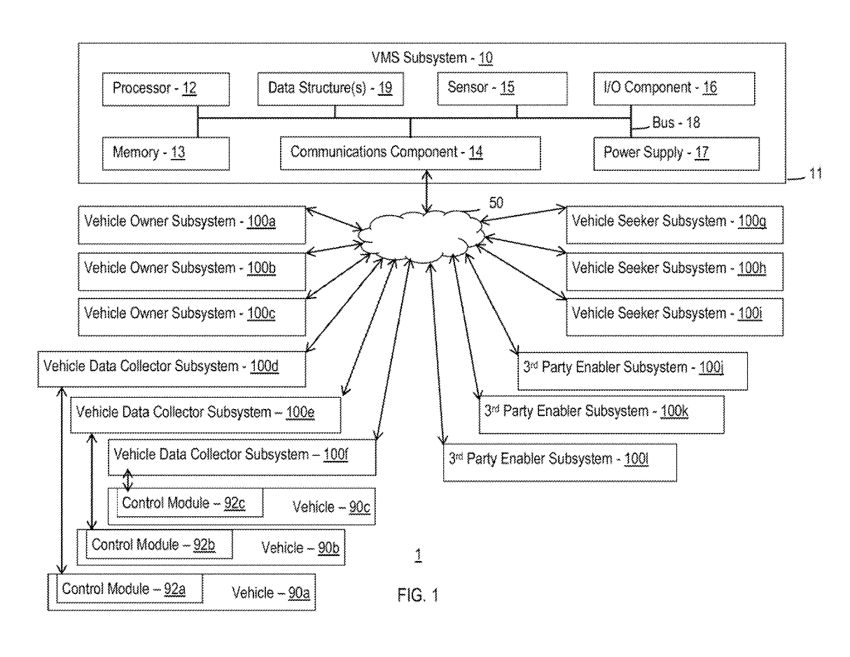

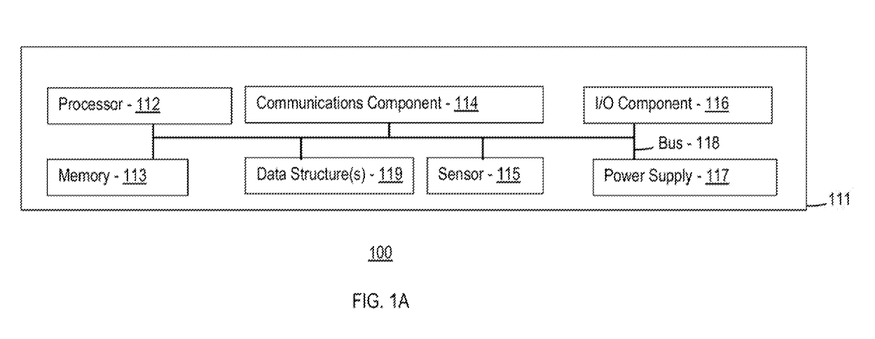

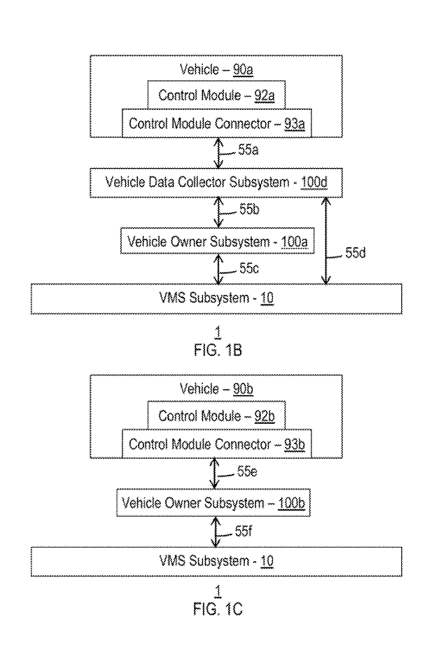

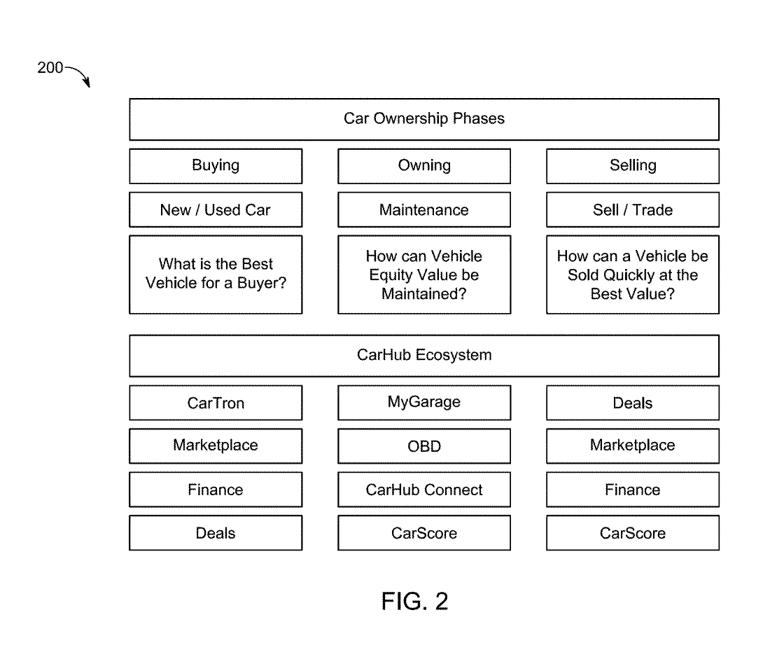

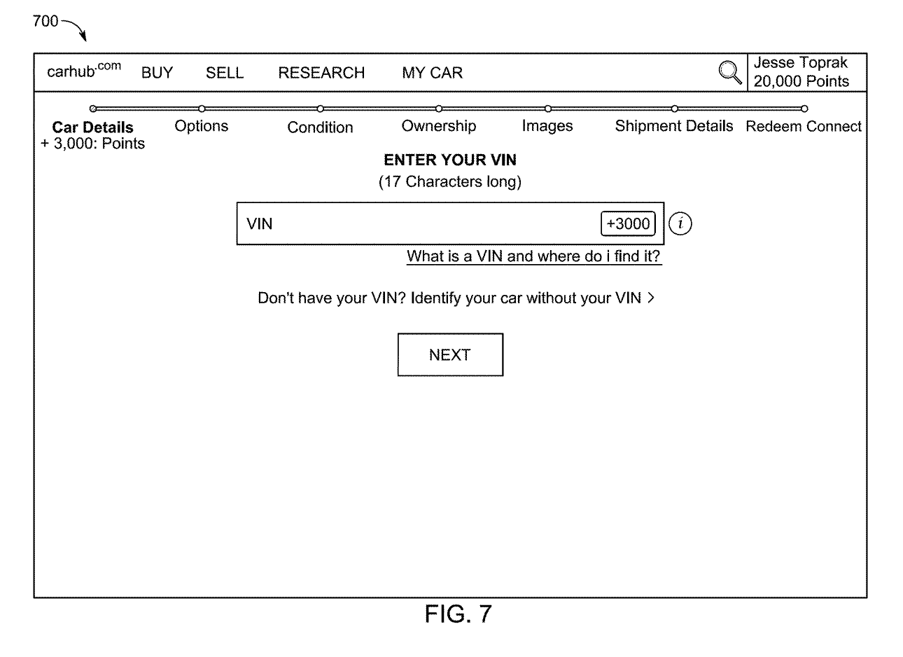

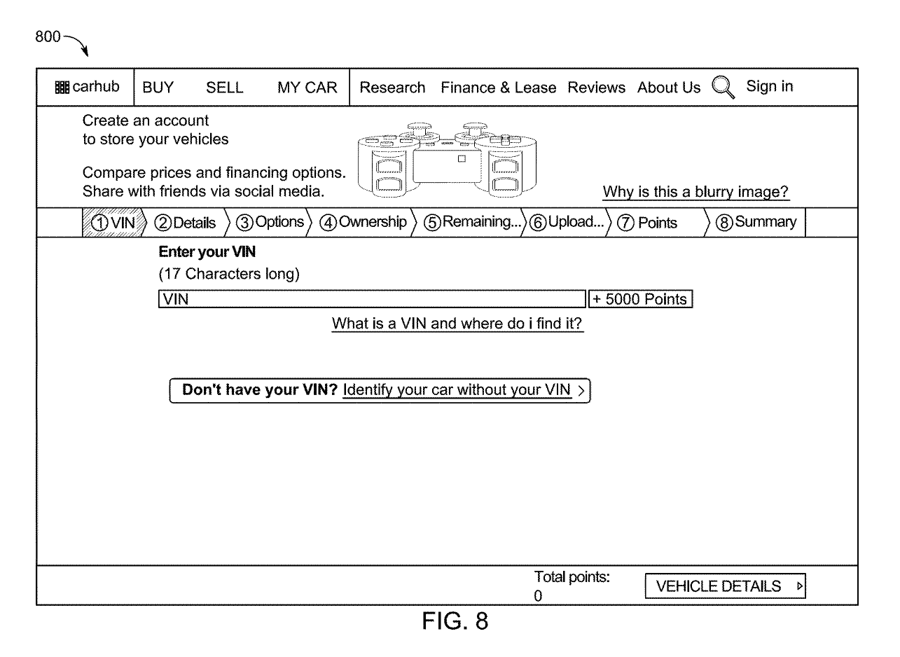

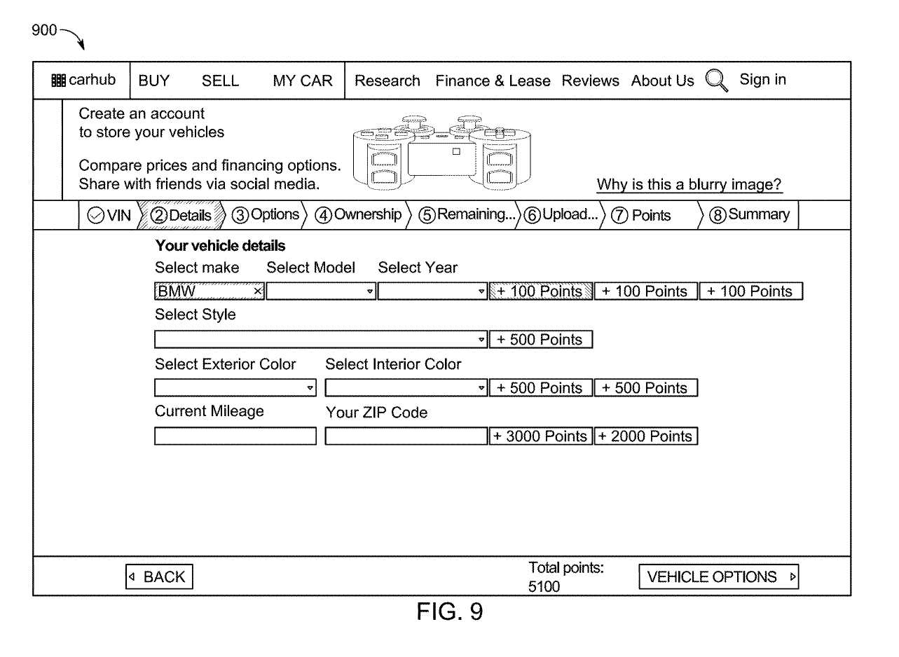

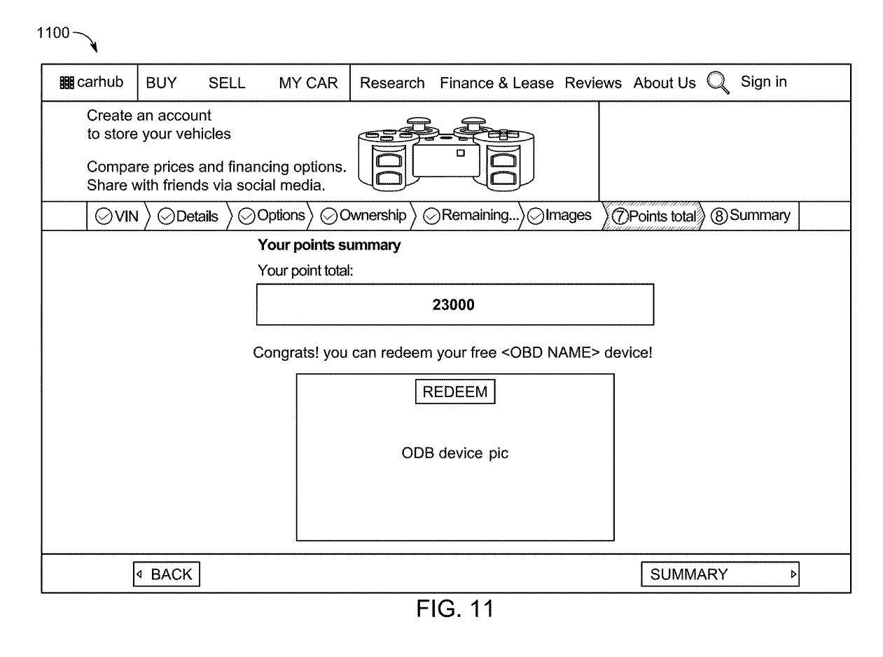

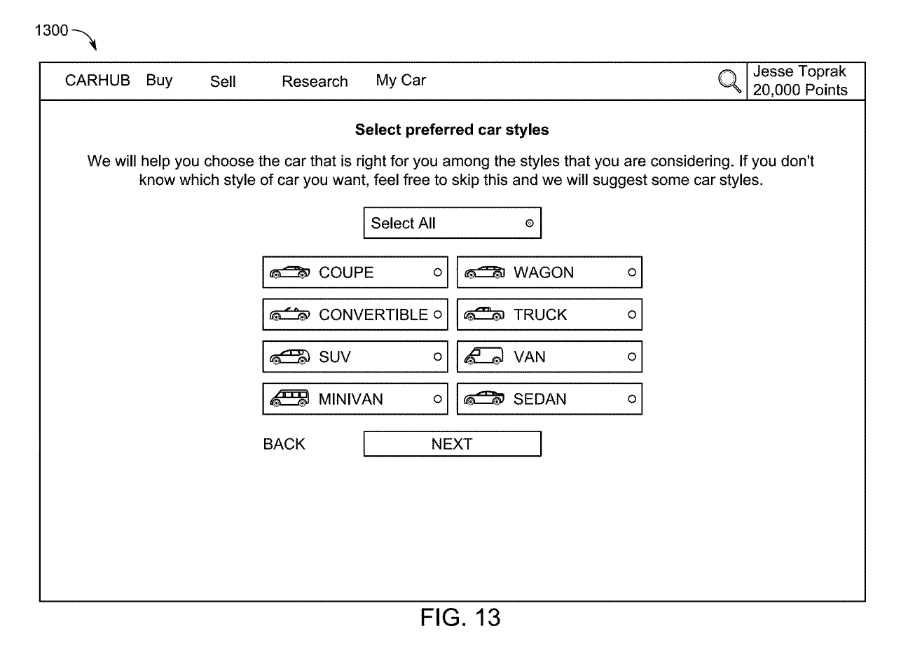

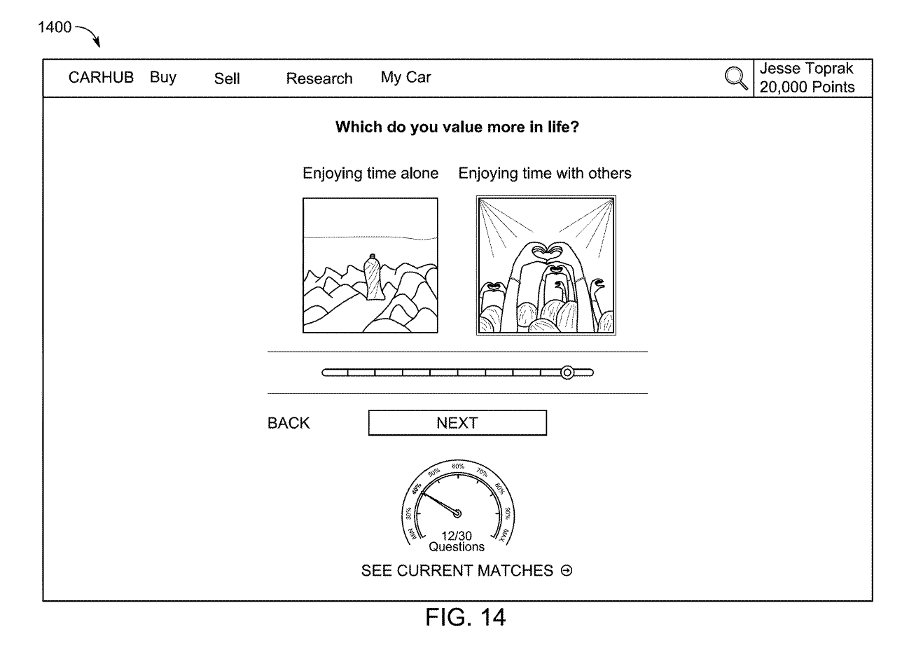

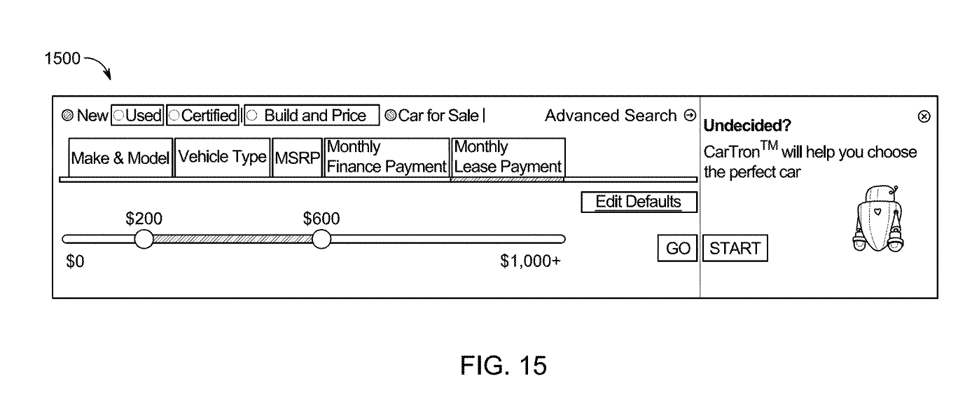

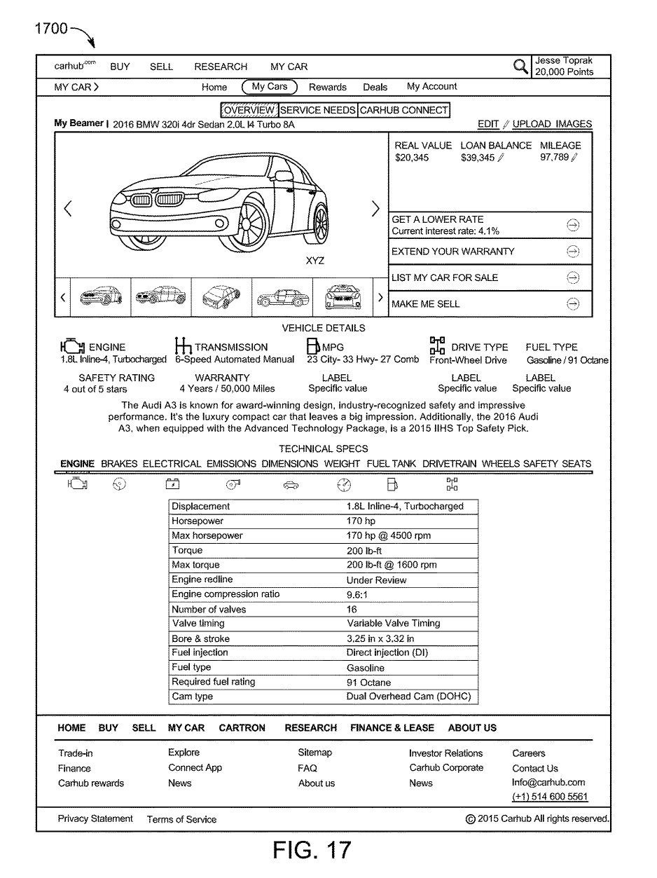

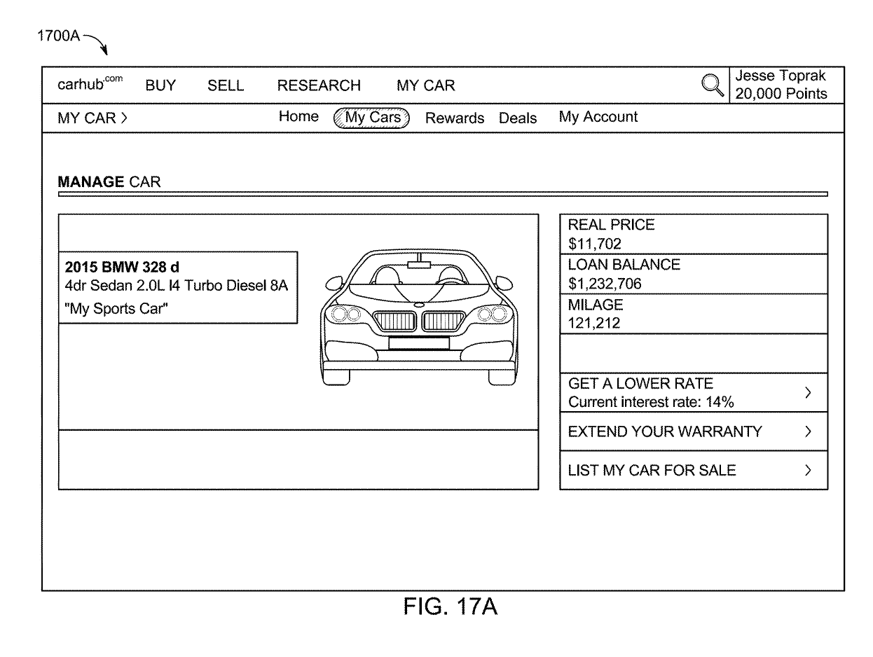

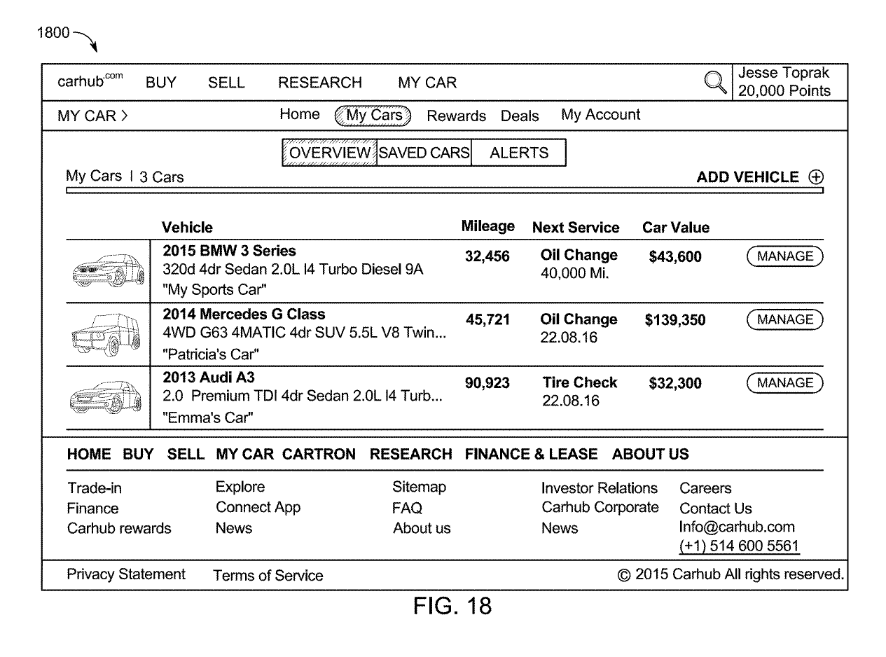

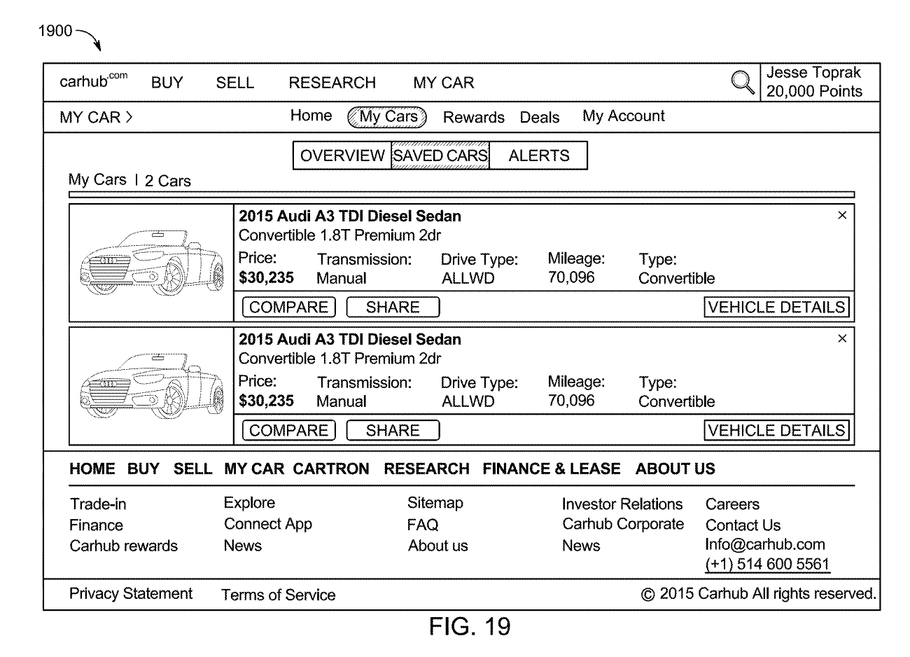

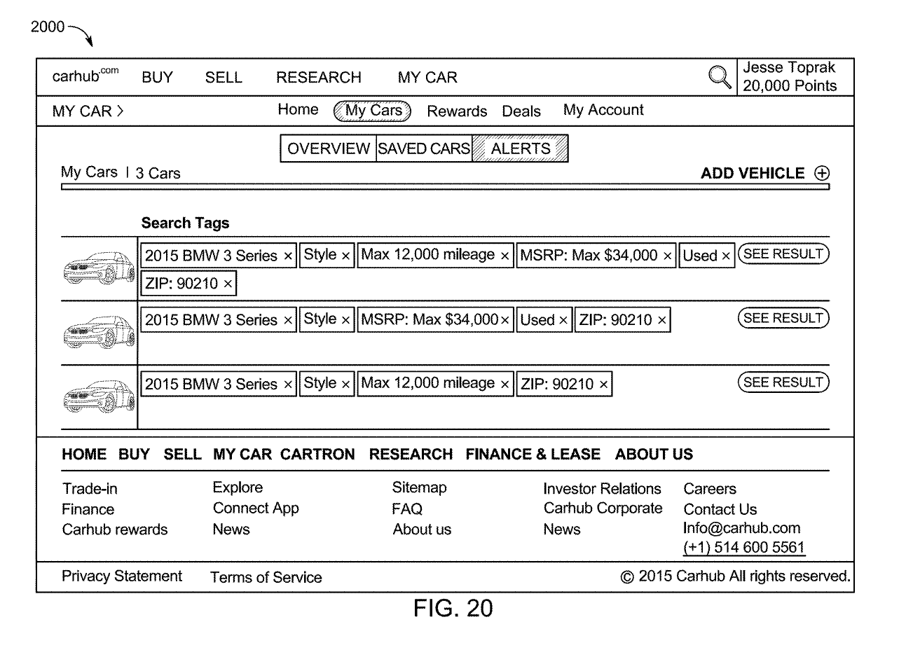

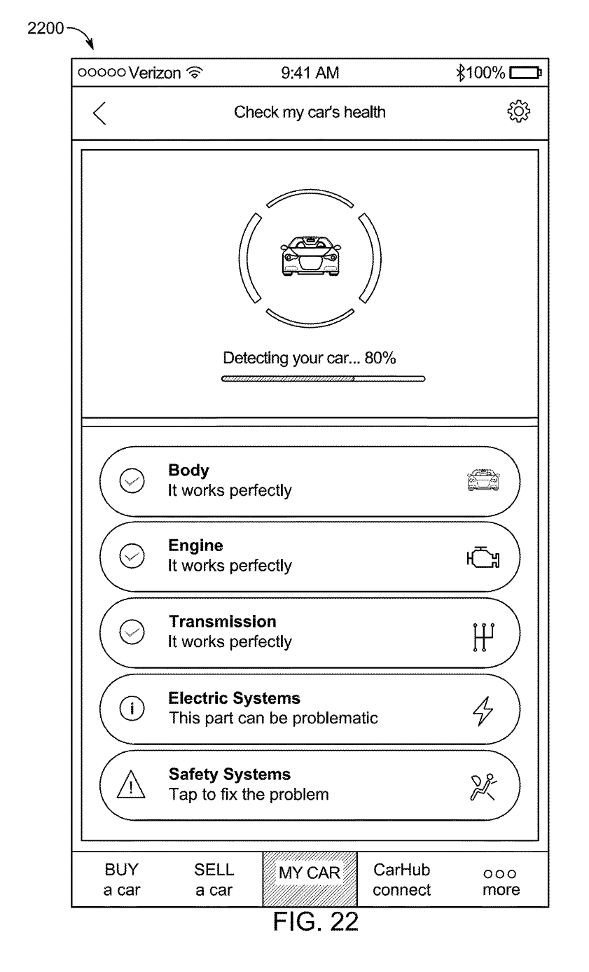

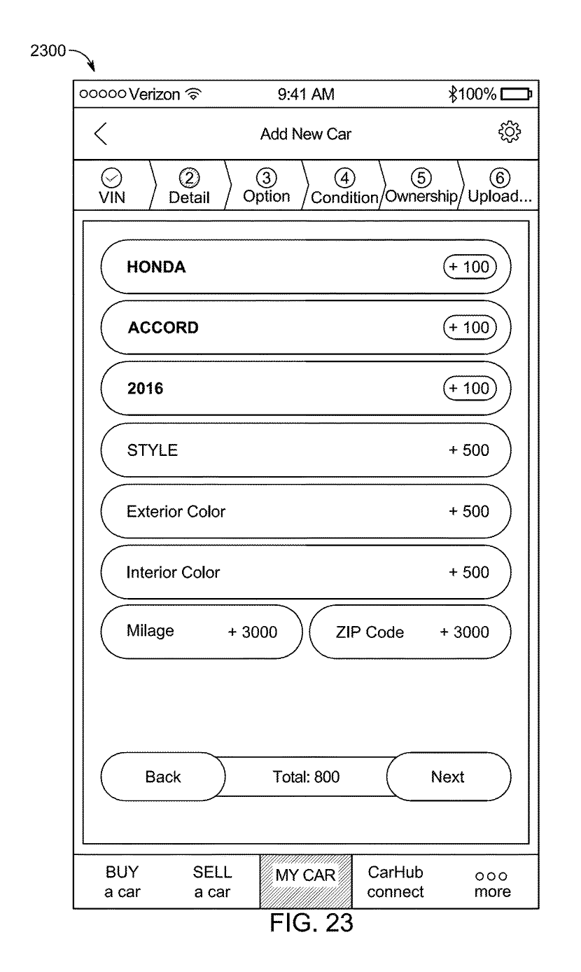

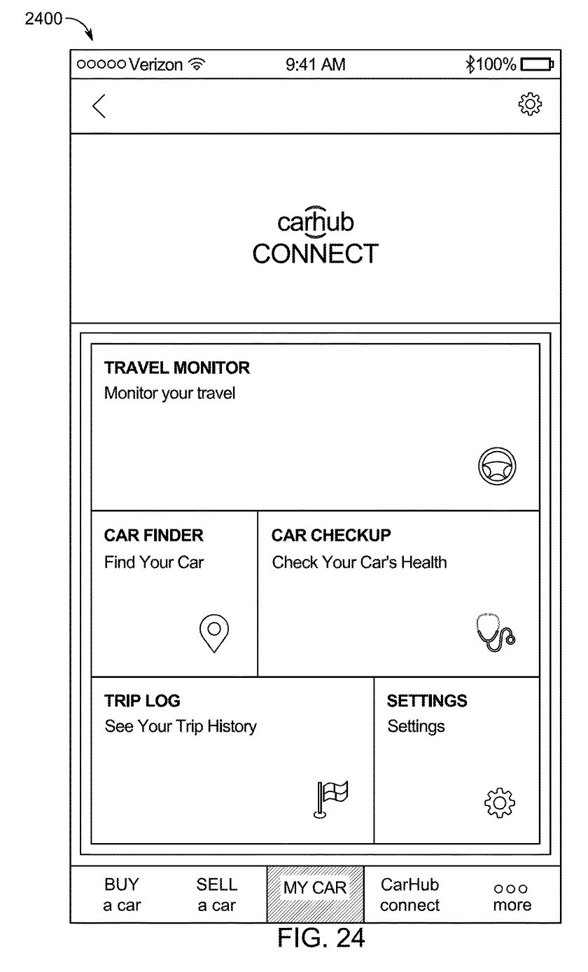

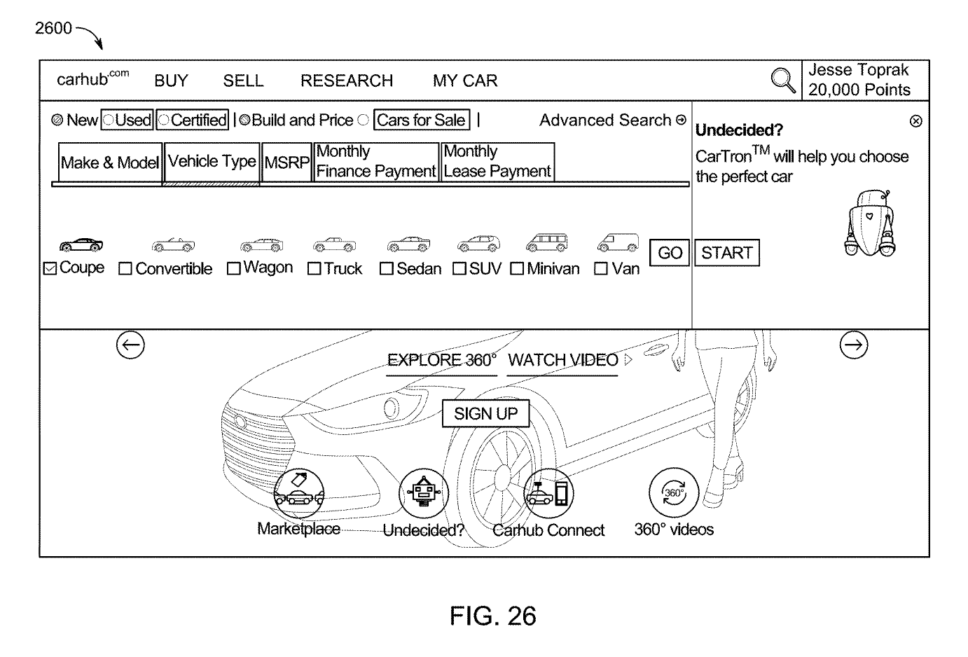

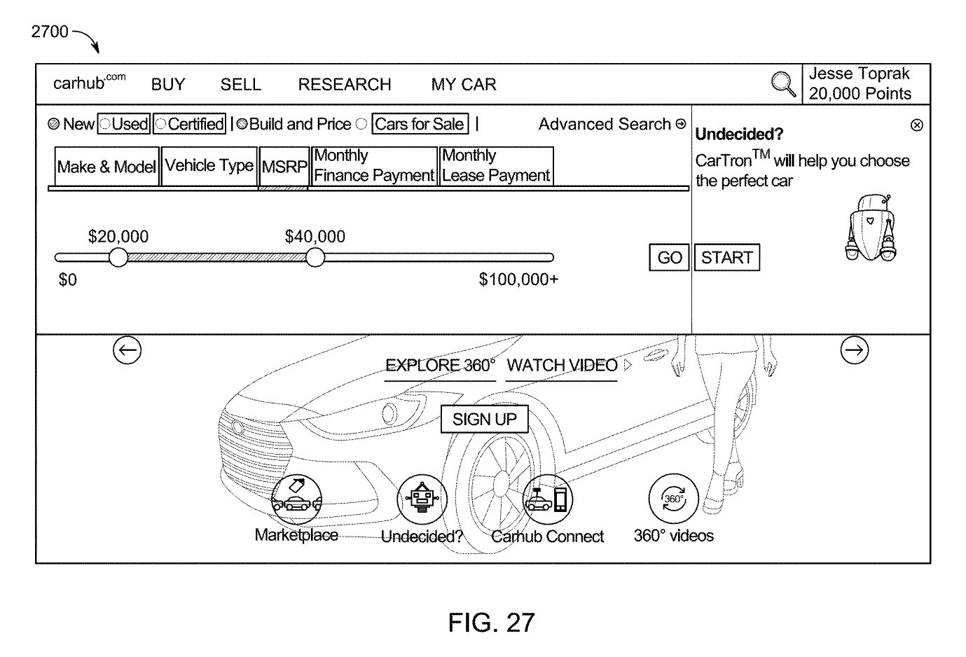

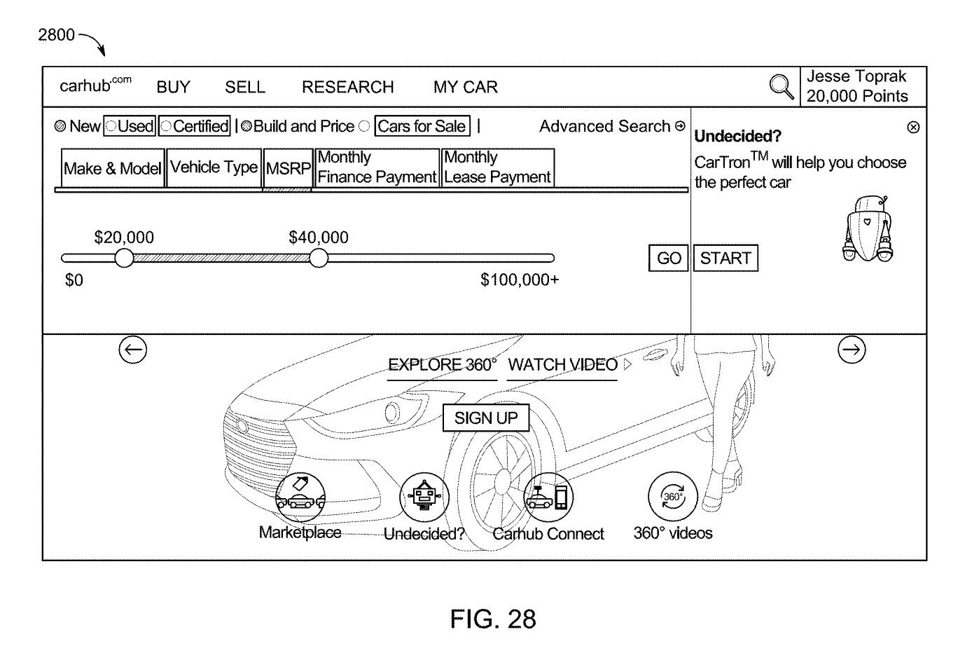

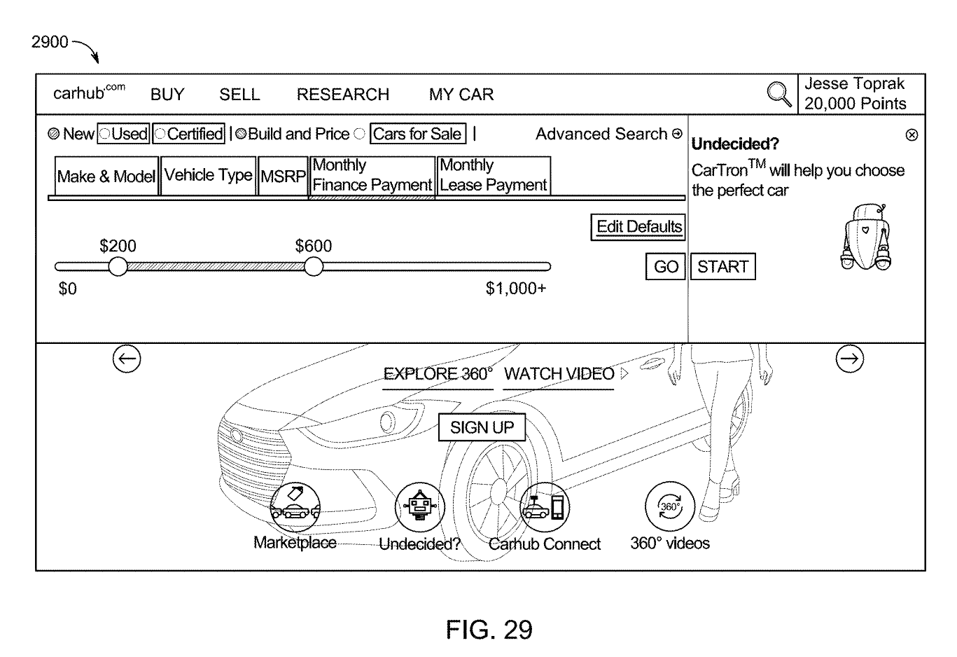

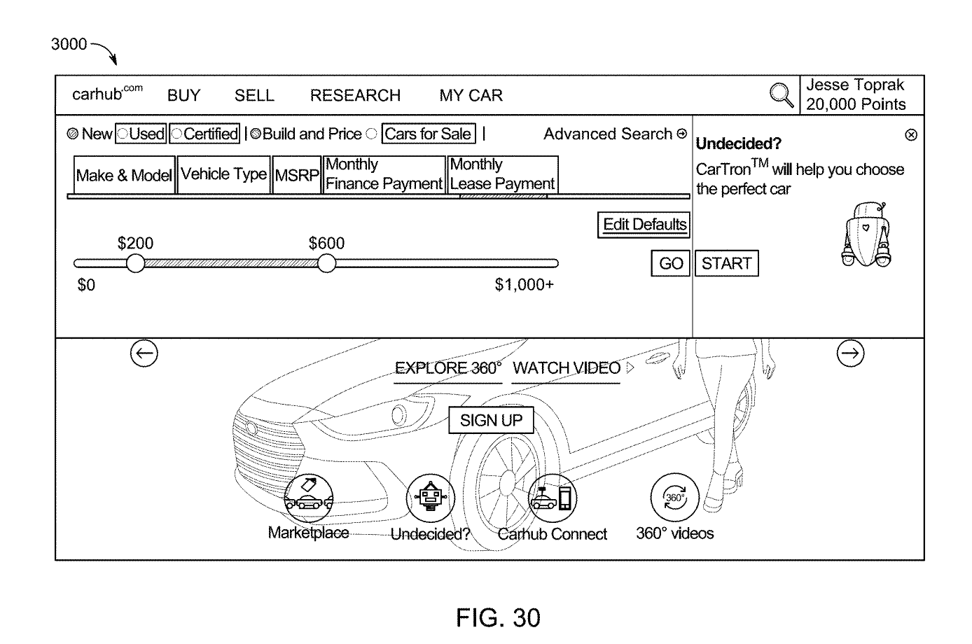

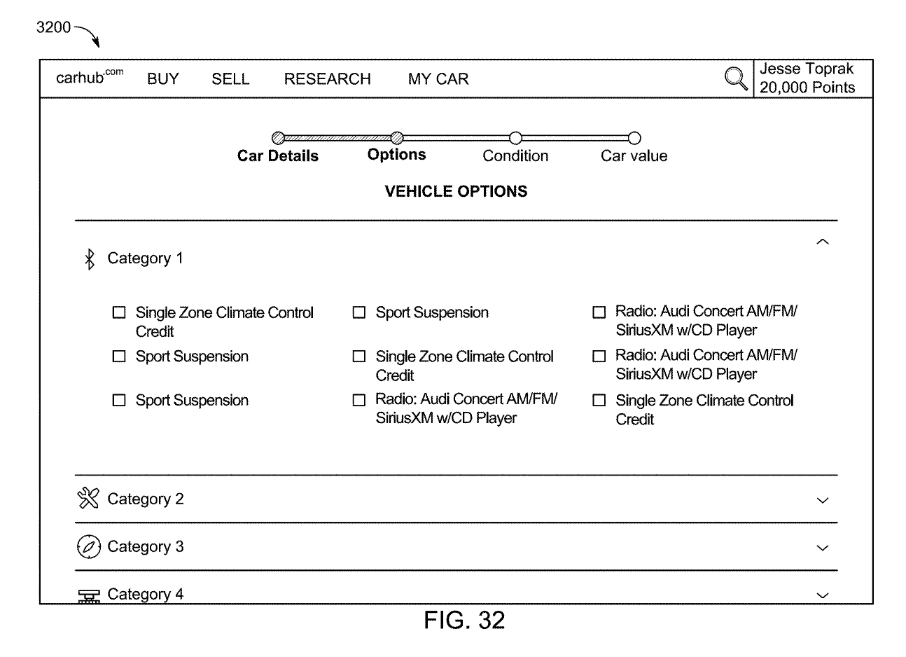

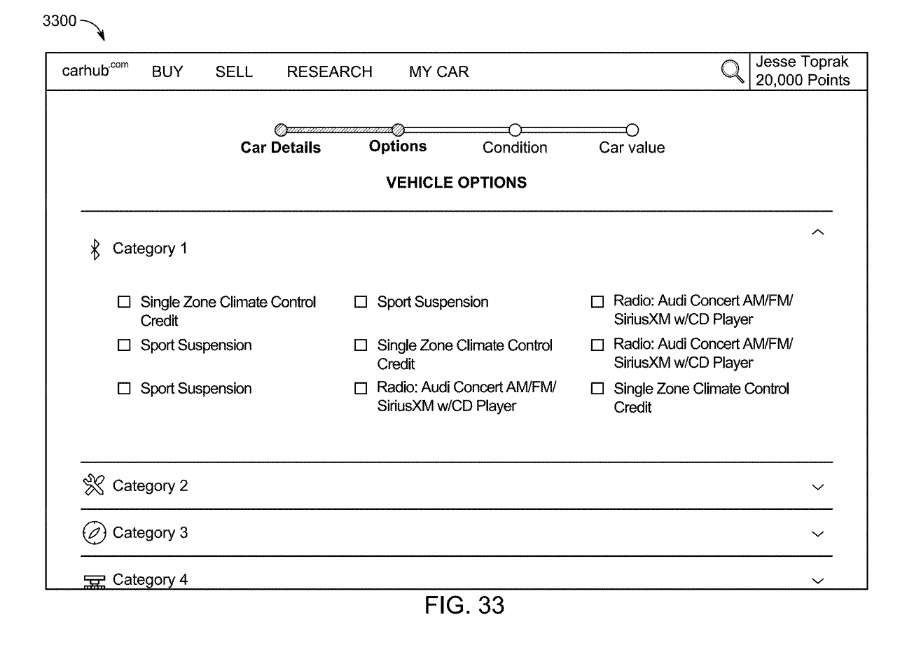

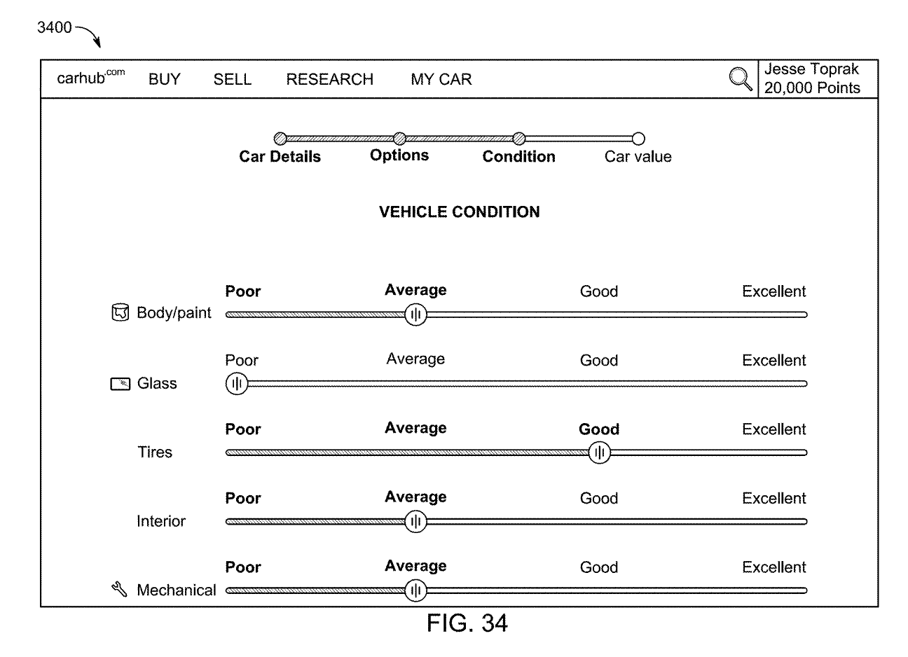

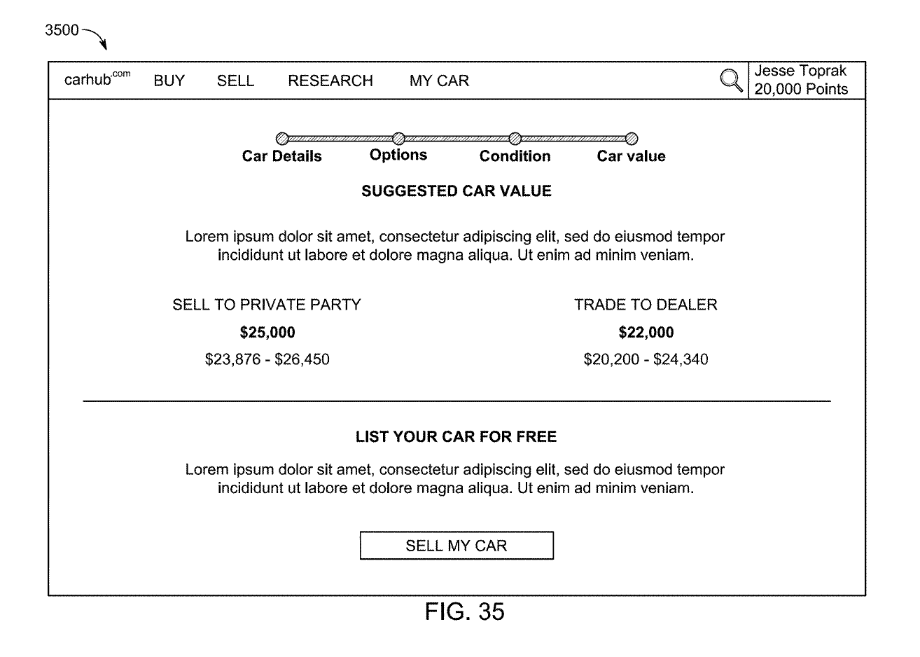

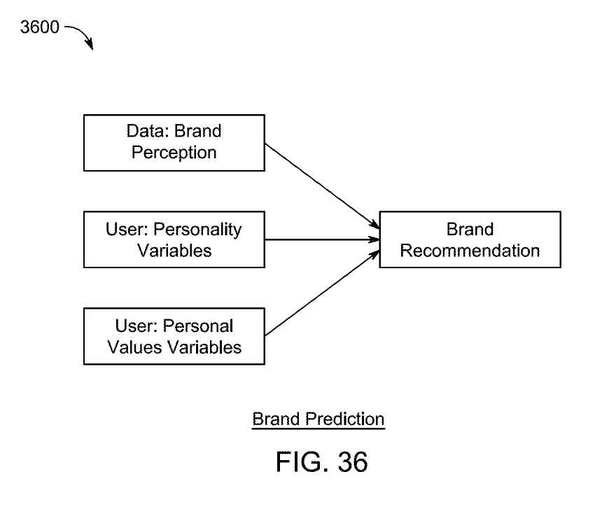

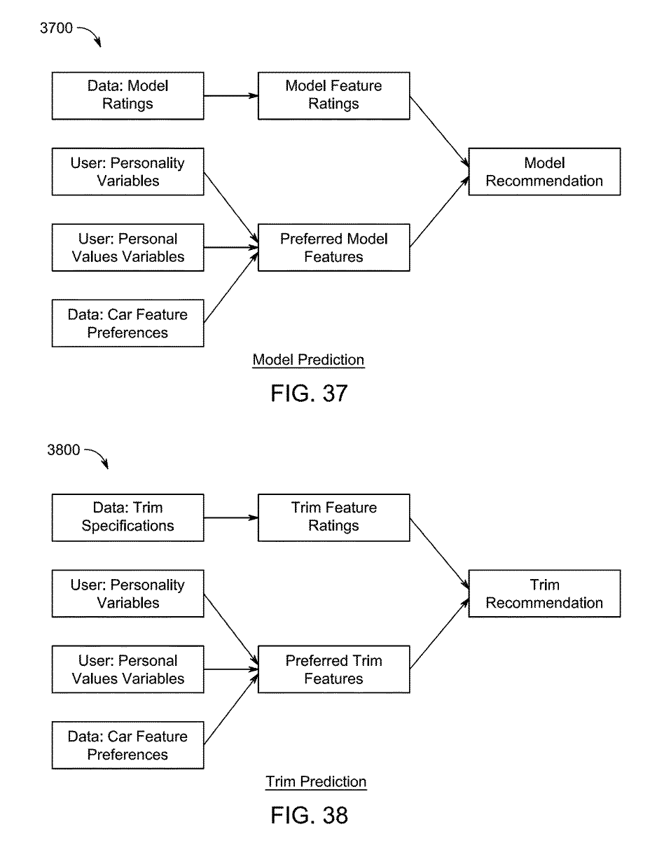

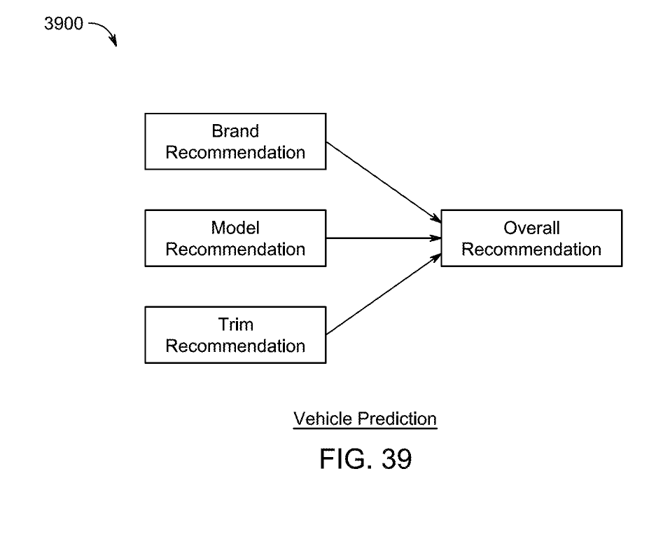

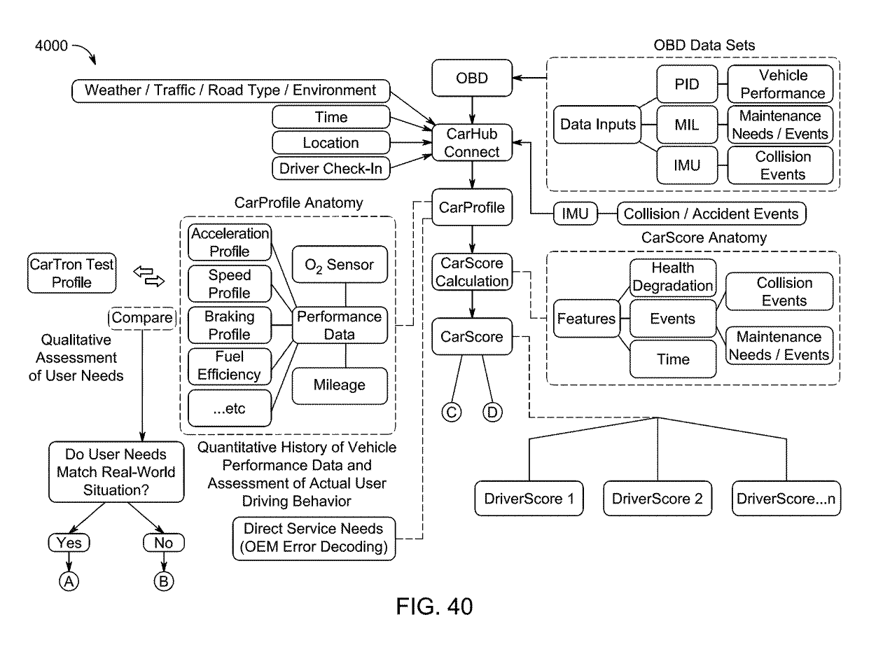

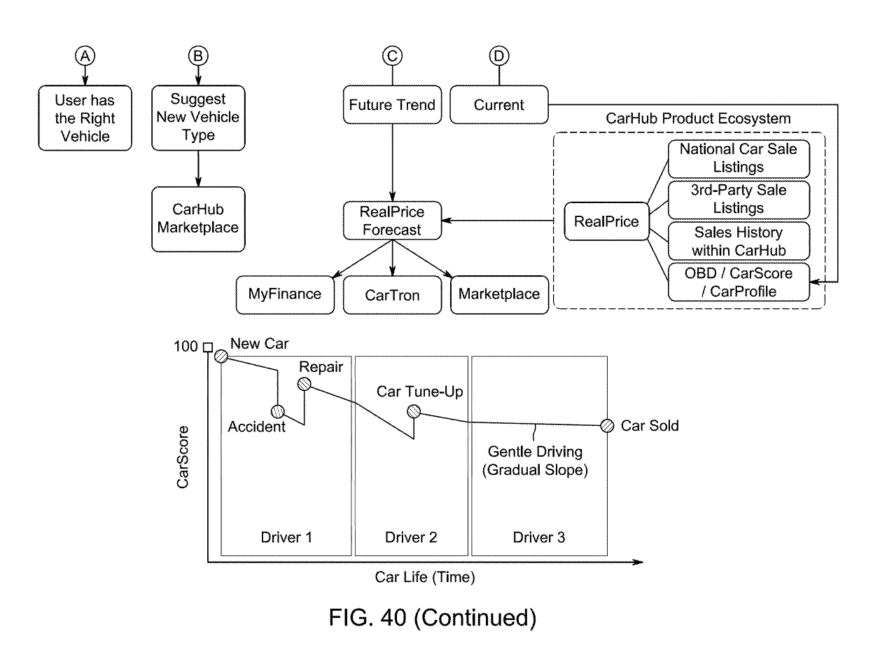

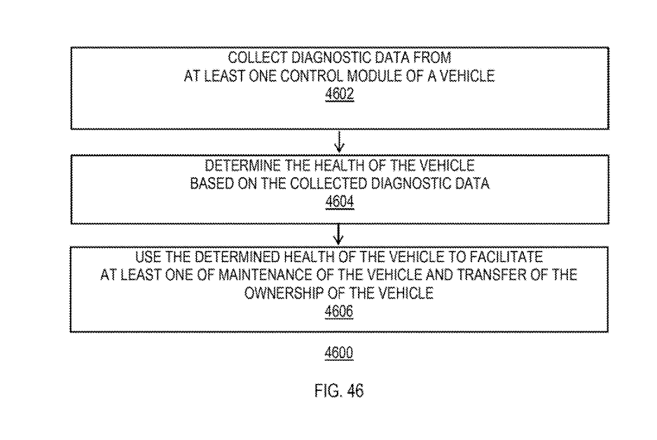

FIG. 1 shows a system 1 in which a vehicle management service may be facilitated amongst various entities, FIG. 1A shows further details with respect to a particular embodiment of a subsystem of system 1, FIGS. 1B and 1C are more detailed schematic views of different portions of the system of FIG. 1, FIGS. 2-6 show diagrams illustrating various products and schemes of the vehicle management service, FIGS. 7-35 are screen shots of various illustrative user interfaces that may be provided by any suitable subsystem for any suitable user of the vehicle management service, FIGS. 36-39 are schematics showing various variables that may be used to make various recommendations for the vehicle management service, FIGS. 40-45 are diagrams showing various functionalities of the vehicle management service of the disclosure, and FIG. 46 is a flowchart of an illustrative process that may provide features of the vehicle management service of the disclosure.

### Description of FIGS. 1-1C

FIG. 1 is a schematic view of an illustrative system 1 in which a vehicle management service may be facilitated amongst various entities. For example, as shown in FIG. 1, system 1 may include a vehicle management service (“VMS”) subsystem 10, various subsystems 100 (e.g., one or more vehicle owner (“VO”) subsystems 100a-100c, one or more vehicle data collector (“VDC”) subsystems 100d-100f, each of which may be communicatively coupled to one or more control modules (“CMs”) 92 of a respective vehicle 90 (e.g., CMs 92a-92c of respective vehicles 90a-90c that may be owned by of owners of respective vehicle owner subsystems 100a-100c) and to a respective VO subsystem (e.g., VO subsystems 100a-100c), one or more vehicle seeker (“VS”) subsystems 100g-100i, and/or one or more third party enabler (“TPE”) subsystems 100j-1001), and at least one communications network 50 through which any two or more of the subsystems 10 and 100 may communicate. VMS subsystem 10 may be operative to interact with any of the various subsystems 100 to provide a vehicle management service platform (“VMSP”) that may facilitate various vehicle management services, including, but not limited to, managing and enhancing the vehicle ownership process for vehicle buyers, vehicle users, and vehicle sellers for enabling effective and efficient vehicle transactions.

As shown in FIG. 1A, and as described in more detail below, a subsystem 100 may include a processor component 112, a memory component 113, a communications component 114, a sensor component 115, an input/output (“I/O”) component 116, a power supply component 117, and/or a bus 118 that may provide one or more wired or wireless communication links or paths for transferring data and/or power to, from, or between various other components of subsystem 100. I/O component 116 may include at least one input component (e.g., a button, mouse, keyboard, microphone, input connector, etc.) to receive information from a user of subsystem 100 and/or at least one output component (e.g., an audio speaker, video display, haptic component, output connector, etc.) to provide information to a user of subsystem 100, such as a touch screen that may receive input information through a user's touch on a touch sensitive portion of a display screen and that may also provide visual information to a user via that same display screen. Memory 113 may include one or more storage mediums, including for example, a hard-drive, flash memory, permanent memory such as read-only memory (“ROM”), semi-permanent memory such as random access memory (“RAM”), any other suitable type of storage component, or any combination thereof. Communications component 114 may be provided to allow one subsystem 100 to communicate with a communications component of one or more other subsystems 100 or subsystem 10 or servers using any suitable communications protocol (e.g., via communications network 50). Communications component 114 can be operative to create or connect to a communications network for enabling such communication. Communications component 114 can provide wireless communications using any suitable short-range or long-range communications protocol, such as Wi-Fi (e.g., an 802.11 protocol), Bluetooth, radio frequency systems (e.g., 1200 MHz, 2.4 GHz, and 5.6 GHz communication systems), infrared, protocols used by wireless and cellular telephones and personal e-mail devices, or any other protocol supporting wireless communications. Communications component 114 can also be operative to connect to a wired communications network or directly to another data source wirelessly or via one or more wired connections or a combination thereof. Such communication may be over the internet or any suitable public and/or private network or combination of networks (e.g., one or more networks 50). Sensor 115 may be any suitable sensor that may be configured to sense any suitable data from an external environment of subsystem 100 or from within or internal to subsystem 100 (e.g., light data via a light sensor, audio data via an audio sensor, location-based data via a location-based sensor system (e.g., a global positioning system (“GPS”)), etc.). Power supply 117 can include any suitable circuitry for receiving and/or generating power, and for providing such power to one or more of the other components of subsystem 100. Subsystem 100 may also be provided with a housing 111 that may at least partially enclose one or more of the components of subsystem 100 for protection from debris and other degrading forces external to subsystem 100. Each component of subsystem 100 may be included in the same housing 111 (e.g., as a single unitary device, such as a laptop computer or portable media device) and/or different components may be provided in different housings (e.g., a keyboard input component may be provided in a first housing that may be communicatively coupled to a processor component and a display output component that may be provided in a second housing, and/or multiple servers may be communicatively coupled to provide for a particular subsystem). In some embodiments, subsystem 100 may include other components not combined or included in those shown or several instances of the components shown.

Processor 112 may be used to run one or more applications, such as an application that may be provided as at least a part of one data structure 119 that may be accessible from memory 113 and/or from any other suitable source (e.g., from VMS subsystem 10 via an active internet connection or otherwise). Such an application data structure 119 may include, but is not limited to, one or more operating system applications, firmware applications, communication applications, internet browsing applications (e.g., for interacting with a website provided by VMS subsystem 10 for enabling subsystem 100 to interact with an online service of VMS subsystem 10 (e.g., a VMSP)), VMS applications (e.g., a web application or a native application or a hybrid application that may be at least partially produced by VMS subsystem 10 for enabling subsystem 100 to interact with an online service of VMS subsystem 10 (e.g., a VMSP)), or any other suitable applications. For example, processor 102 may load an application data structure 119 as a user interface program to determine how instructions or data received via an input component of I/O component 116 or via communications component 114 or via sensor component 115 or via any other component of subsystem 100 may manipulate the way in which information may be stored and/or provided to a user via an output component of I/O component 116 and/or to any other subsystem via communications component 114. As one example, an application data structure 119 may provide a user or a communicatively coupled device (e.g., control module 92) with the ability to interact with a vehicle management service or the VMSP of VMS subsystem 10, where such an application 119 may be a third party application that may be running on subsystem 100 (e.g., an application (e.g., software and/or firmware) associated with VMS subsystem 10 that may be loaded on subsystem 100 from VMS subsystem 10 or via an application market) and/or that may be accessed via an internet application or web browser running on subsystem 100 (e.g., processor 112) that may be pointed to a uniform resource locator (“URL”) whose target or web resource may be managed by VMS subsystem 10 or any other remote subsystem. Each subsystem 100 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application, for presentation on one or more other subsystems) with an interface for an administrator of such a server, and/or the like.

VMS subsystem 10 may include a housing 11 that may be similar to housing 111, a processor component 12 that may be similar to processor 112, a memory component 13 that may be similar to memory component 113, a communications component 14 that may be similar to communications component 114, a sensor component 15 that may be similar to sensor component 115, an I/O component 16 that may be similar to I/O component 116, a power supply component 17 that may be similar to power supply component 117, and/or a bus 18 that may be similar to bus 118. Moreover, VMS subsystem 10 may include one or more data sources or data structures or applications 19 that may include any suitable data or one or more applications (e.g., any application similar to application 119) for facilitating a vehicle management service or VMSP that may be provided by VMS subsystem 10 in conjunction with one or more subsystems 100. Some or all portions of VMS subsystem 10 may be operated, managed, or otherwise at least partially controlled by an entity (e.g., administrator) responsible for providing a vehicle management service to one or more clients or other suitable entities.

VMS subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 100 may access information (e.g., from a data structure 19 of VMS subsystem 10, as may be provided as a vehicle management service via processor 12 and communications component 14 of VMS subsystem 10) as if such information were stored locally at that subsystem 100 (e.g., in memory component 113)).

Various clients and/or partners may be enabled to interact with VMS subsystem 10 for enabling the vehicle management services and the VMSP. For example, at least one vehicle owner subsystem of system 1 (e.g., each one of the one or more vehicle owner subsystems 100a-100c) may be any suitable subsystem (e.g., portable computer) operated by any suitable vehicle owner (“VO”) that may own, rent, or otherwise have access to a vehicle (e.g., a respective one of the one or more vehicles 90a-90c (e.g., any suitable motor vehicle (e.g., car, truck, bus, motorcycle, etc.), railed vehicle (e.g., train, tram, etc.), watercraft (e.g., ship, boat, jet ski, etc.), aircraft (e.g., airplane, helicopter, drone, etc.), spacecraft, and/or the like)). At least one vehicle data collector subsystem of system 1 (e.g., each one of the one or more vehicle data collector subsystems 100d-1000 may be any suitable subsystem (e.g., dongle device) that may be communicatively coupled to a respective vehicle owner subsystem (e.g., via a network 50) and to a respective control module (e.g., via direct installation) of a respective vehicle (e.g., VDC subsystem 100d may be communicatively coupled to VO subsystem 100a and to CM 92a of vehicle 90a that may be owned by the operator of VO subsystem 100a, VDC subsystem 100e may be communicatively coupled to VO subsystem 100b and to CM 92b of vehicle 90b that may be owned by the operator of VO subsystem 100b, and VDC subsystem 100f may be communicatively coupled to VO subsystem 100c and to CM 92c of vehicle 90c that may be owned by the operator of VO subsystem 100c). For example, a VDC subsystem may be any suitable on-board diagnostics (“OBD”) device that may be operative to be communicatively coupled with any suitable control module of any suitable vehicle (e.g., via any suitable OBD-II data link connector of a vehicle (e.g., via a physical connection or wireless path)) that may be operative to monitor any suitable data from an engine control unit (“ECU”) of the vehicle and/or from any other data source of the vehicle that may be made available (e.g., according to the OBD protocol), such as a powertrain control module (“PCM”) or otherwise. A VDC subsystem may be operative to send one or more requests to the CM of a vehicle for one or more specific parameters using one or more specific parameter identification numbers (“PIDs”) (e.g., according to the Society of Automotive Engineers (“SAE”) standard J1979) and then the VDC subsystem may communicate any received parameter data from the vehicle to a VO subsystem that may be communicatively coupled to the VDC subsystem (e.g., via any suitable wired or wireless communication protocol). For example, as shown in FIG. 1B, VDC subsystem 100d may be communicatively coupled to any suitable control module connector 93a via any suitable communications path 55a, which may be a direct physical connection between connector 93a and a connector of VDC subsystem 100d (e.g., a male connector of an I/O component 116 of VDC subsystem 100d may physically mate with a female control module connector 93a (e.g., any suitable OBD-II data link connector)), where control module connector 93a may be communicatively coupled to one, some, or all suitable control modules or data sources (e.g., control module 92a) of vehicle 90a, while VDC subsystem 100d may be communicatively coupled to VO subsystem 100a via any suitable communications path 55b (e.g., any suitable wired or wireless communications path using any suitable communications protocol (e.g., Bluetooth between a communications component 114 of VDC subsystem 100d and a communications component 114 of VO subsystem 100a), while VO subsystem 100a may be communicatively coupled to VMS subsystem 10 via any suitable communications path 55c (e.g., any suitable wired or wireless communications path (e.g., of network 50 of FIG. 1) using any suitable communications protocol). Alternatively or additionally, as shown in FIG. 1B, VDC subsystem 100d may be communicatively coupled to VMS subsystem 10 via any suitable communications path 55d (e.g., any suitable wired or wireless communications path (e.g., of network 50 of FIG. 1) using any suitable communications protocol (e.g., any suitable long-range communications protocol between a communications component 114 of VDC subsystem 100d and a communications component 14 of VMS subsystem 10 (e.g., using a low power communications component and/or any suitable telemetry functionality)) without VO subsystem 100a as an intermediary. Additionally or alternatively, in some embodiments, a VO subsystem may be configured to communicate directly with a CM of a vehicle without the need for a distinct intermediary VDC subsystem. For example, as shown in FIG. 1C, VO subsystem 100b may be communicatively coupled to any suitable control module connector 93b via any suitable communications path 55e, which may be a direct wired connection between connector 93b and a connector of VO subsystem 100b (e.g., a connector of an I/O component 116 of VO subsystem 100b may be communicatively coupled to a first connector of a cable of communications path 55e and a second connector of such a cable may be communicatively coupled with control module connector 93b (e.g., any suitable OBD-II data link connector)), where control module connector 93b may be communicatively coupled to one, some, or all suitable control modules or data sources (e.g., control module 92b) of vehicle 90b, while VO subsystem 100b may be communicatively coupled to VMS subsystem 10 via any suitable communications path 55f (e.g., any suitable wired or wireless communications path (e.g., of network 50 of FIG. 1) using any suitable communications protocol). In some embodiments, communications path 55e may be a wireless communications path between control module 92b and VO subsystem 100b (e.g., a wireless (e.g., Bluetooth) communication path between a communications component 114 of VO subsystem 100b and a communications component of control module 92b of vehicle 90b), such that a data connection may be facilitated directly between a user's portable electronic device and a computer of a vehicle directly through a wireless connection.

At least one vehicle seeker subsystem of system 1 (e.g., each one of the one or more vehicle seeker subsystems 100g-1000 may be any suitable subsystem (e.g., computer) operated by any suitable entity that may be interested in purchasing, renting, leasing, or otherwise gaining access to a vehicle (e.g., one or more of vehicles 90a-90c or otherwise) and that may interface with the VMSP to attempt to identify and gain access to such a vehicle. At least one third party enabler subsystem of system 1 (e.g., each one of the one or more third party enabler subsystems 100j-1001) may be operated by any suitable third party enabler (“TPE”) that may be operative to enable at least partially any suitable operation provided by the VMSP, such as a third party application or service provider that may be operative to process or provide any suitable subject matter that may be used by any other suitable subsystem of system 1 for enabling the VMSP (e.g., financial institutions that may provide any suitable financial information or credit scores for any suitable users or vehicles of the platform, social networks that may provide any suitable connection information between various parties, government agencies/regulators, licensing bodies, third party advertisers, owners of relevant data, sellers of relevant goods/materials, software providers, maintenance service providers, scheduling service providers, location analytic and traffic and mapping software providers, and/or any other suitable third party service provider distinct from a VO, VS, and VMS subsystem 10).

Each subsystem 100 of system 1 (e.g., each one of subsystems 100a-1001) may be operated by any suitable entity for interacting in any suitable way with VMS subsystem 10 (e.g., via network 50) for deriving value from and/or adding value to a service of the VMSP of VMS subsystem 10. For example, a particular subsystem 100 may be a server operated by a client/partner entity that may receive any suitable data from VMS subsystem 10 related to any suitable vehicle management enhancement of the VMSP provided by VMS subsystem 10 (e.g., via network 50). Additionally or alternatively, a particular subsystem 100 may be a server operated by a client/partner entity that may upload or otherwise provide any suitable data to VMS subsystem 10 related to any suitable vehicle management service of the VMSP provided by VMS subsystem 10 (e.g., via network 50).

### Description of FIGS. 2-45

System 1 may be utilized to manage and enhance the vehicle ownership process for vehicle buyers (e.g., users of VS subsystems), vehicle users (e.g., users of VO subsystems with VDC subsystems and vehicles 90), and vehicle sellers (e.g., users that may want to sell a vehicle 90) for enabling effective and efficient vehicle transactions. Such management and enhancement may be provided by monitoring vehicle diagnostic data (e.g., from one or more control modules of a vehicle) and using such vehicle diagnostic data to enable a user of the vehicle to better care for the vehicle, a seller of the vehicle to better understand the value of the vehicle, and a potential buyer of the vehicle to better understand the health of the vehicle. Therefore, system 1 and methods of use of system 1 and the VMSP (e.g., hereinafter often referred to herein as “CarHub”) may manage vehicle lifecycle and marketplace logistics to maintain the equity value of a vehicle and enable the selling or buying of a vehicle in an accelerated and efficient way. A method may be provided to qualitatively evaluate the vehicle ownership needs of a vehicle seeker (“VS”) system user (e.g., hereinafter often referred to herein as a “Cartron” feature of the VMSP). Such vehicle ownership needs can be used by the VMSP (e.g., Cartron) to determine a vehicle make/model type that would fulfill the needs of the VS, and then the VMSP may be operative to match the VS with one or more available new or used vehicles available for purchase and/or rent and/or lease (e.g., within the location of the VS or otherwise) that may be known by the VMSP (e.g., hereinafter often referred to herein as a “Marketplace” feature of the VMSP).

While owning and operating a vehicle 90, a VO subsystem directly or via a VDC subsystem (hereinafter often referred to herein as an “OBD” product of the VMSP) may request and/or collect vehicle diagnostic data (e.g., hereinafter often referred to herein as “on-board diagnostic data”) from one or more control modules of vehicle 90 during use of vehicle 90, and such vehicle diagnostic data may then be quantified together with other factors, including accident and maintenance events that may be detected by one or more sensors of the VO subsystem or VDC subsystem or other data collected by such subsystems, in order to calculate any suitable information, such as a number, that may represent the condition of the vehicle (e.g., hereinafter often referred to herein as a “CarScore” feature of the VMSP). For example, such other data may include location data (e.g., GPS data and/or road condition data and/or incline data and/or the like) indicative of the location of the vehicle that may be collected by the VMSP by any suitable sensor(s), such as one or more sensors 115 of a vehicle owner subsystem and/or of a vehicle data collector subsystem and/or one or more sensors of the vehicle itself, and/or may be determined by any suitable source data (e.g., mapping data that may be provided by VMS subsystem 10 and/or from a third party enabler subsystem (e.g., a mapping and/or traffic application data provider)). Alternatively or additionally, such other data may include weather data indicative of the weather or any other environmental conditions of the vehicle's environment that may be collected by the VMSP by any suitable sensor(s), such as one or more sensors 115 of a vehicle owner subsystem and/or of a vehicle data collector subsystem and/or one or more sensors of the vehicle itself, and/or may be determined by any suitable source data (e.g., weather data that may be provided by VMS subsystem 10 and/or from a third party enabler subsystem (e.g., a weather application data provider)). In some embodiments, such on-board diagnostic data may be collected by a VO subsystem that may be running any suitable mobile or native or hybrid or web-based application (e.g., a portion of a data structure 119 of the VO subsystem) that may be associated with the VMSP (e.g., hereinafter often referred to herein as a “CarHub Connect” app feature of the VMSP), whereby at least a portion of such data may be communicated to VMS subsystem 10 or a suitable TPE subsystem of the VMSP for additional processing or any other suitable use (e.g., for use in facilitating the sale of the vehicle or further evaluating the CarScore of the vehicle). Various user products or features that may be provided by the VMSP may be accessible to a user via such a CarHub Connect app that may be running on the user's subsystem (e.g., via any online resource or local app that may be operative to share information of the VMSP with the user). Such VMSP products may include a central application (e.g., hereinafter often referred to herein as a “MyCar” feature and/or a “MyGarage” feature of the VMSP) that may be accessed by a user's subsystem that may be operative to present and track the condition and/or health and/or financial status of a vehicle. In some embodiments, such a MyCar feature may be operative to assist in the maintenance process of the vehicle (e.g., hereinafter often referred to herein as a “MyGarage” feature of the “MyCar” feature of the VMSP), thereby enabling recommendations for vehicle service centers in order to keep the vehicle in good condition (e.g., through vehicle diagnostic data and/or any other suitable vehicle status data accessible by the VMSP, potentially in combination with vehicle manufacturer data and vehicle maintenance service provider data and location data of the vehicle, the VMSP may be operative to determine when a vehicle may be due for a service update and recommend one or more conveniently located vehicle maintenance service providers that may appropriately service the vehicle, so as to promote the health of the vehicle to the user). The selling of a vehicle, or trade-in against a new vehicle purchase, may be managed by the Marketplace of the VMSP and made available through the CarHub Connect app, thereby allowing VS entities to purchase vehicles, where the selling price may be determined based on the diagnostic history of the vehicle (e.g., the suggested vehicle price may be determined based on the CarScore).

As shown by schematic 200 of FIG. 2, the VMSP (e.g., CarHub) may provide various products that may address various phases of vehicle ownership for improving the overall process for one or more types of user of the VMSP. For example, during the ownership process, the OBD product (e.g., with or without any VDC subsystem) of the VMSP may enable the tracking of the health of the vehicle, which may be then quantified in the CarScore. The MyCar and/or MyGarage product may assist in the maintenance process of the vehicle (e.g., by tracking the health and recommending/facilitating maintenance services when applicable), which may ensure that the base value of the vehicle can be kept at a higher level than without usage of the CarHub products due to the health of the car being tracked and optimized. A “Finance” product of the VMSP may enable a user to optimize its loan or lease terms for a vehicle based on their ownership needs and personal financial situation during the buying process and/or during the selling process in the Marketplace product of the VMSP. The CarScore may allow for easy assessment of the true value of the vehicle, giving an easier method for buyers to purchase used vehicles with confidence in the condition of the vehicle. This may also reduce the difficulties a person may have in assessing the value of a vehicle, ensuring they are in the best position to buy a new vehicle and/or sell a current vehicle as their needs change.

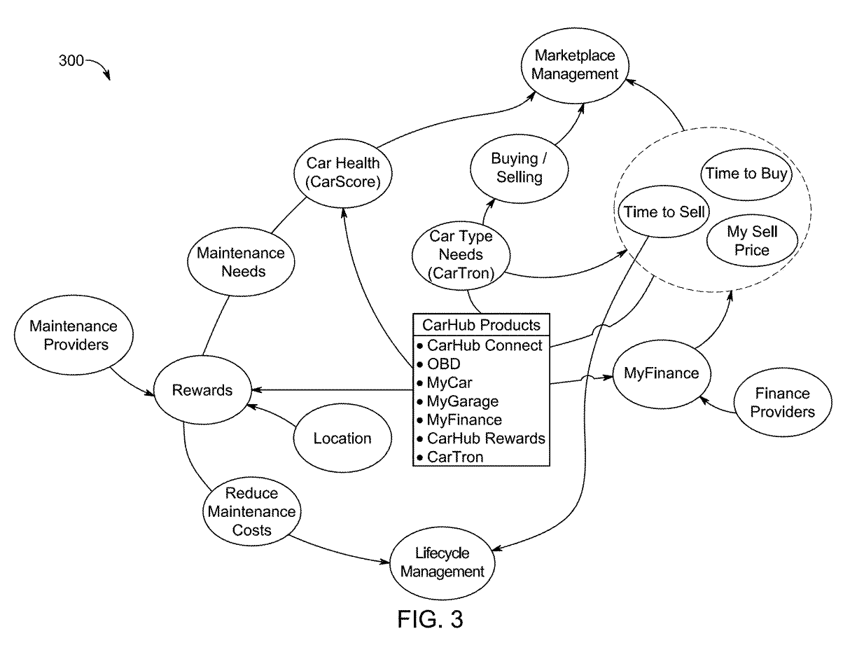

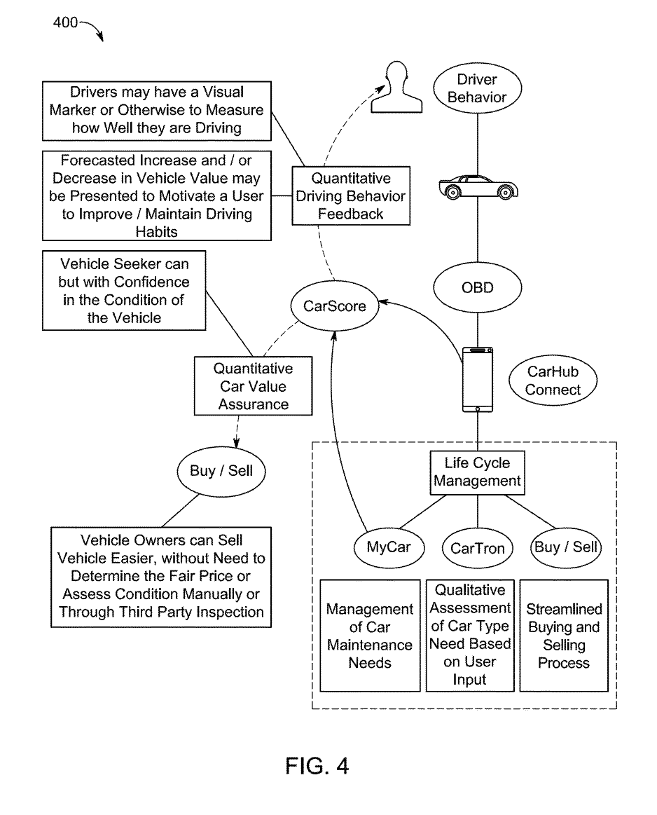

The integration between CarHub products may be shown in diagram 300 of FIG. 3 and/or in diagram 400 of FIG. 4, where the use and combination of qualitative versus quantitative data in the design of the platform is illustrated in FIG. 4. The driving behavior of a CarHub user with a particular vehicle can be quantified in the CarScore (e.g., car health) of the vehicle, which may be directly integrated with the selling process of the vehicle by the VMSP (e.g., in the Marketplace) when a user is ready to sell its vehicle. Each vehicle may be uniquely registered with the VMSP (e.g., with a unique account of VMS subsystem 10) through a verified vehicle identification number (“VIN”) and/or any other suitable unique vehicle identifier(s) that may be identified by a VDC subsystem and/or vehicle owner subsystem or VMS subsystem of system 1. Multiple users may operate the same vehicle, but each user may check-in to the vehicle for personal operation of the vehicle (e.g., using an application of the VMSP that may be running on a vehicle owner subsystem of that user (e.g., such that not only may each vehicle be associated with its own account data on the VMSP, but also such that the operation of a single vehicle by different user operators may be tracked and/or such that operation of different vehicles by a single user operator may be tracked)). Therefore, the unique identifier of each vehicle (e.g., as may be determined by a VDC subsystem or otherwise) may be linked to the operation time of individual users, as each user's VMSP account may be paired uniquely with the VDC subsystem and/or with the vehicle (e.g., only one vehicle owner subsystem (e.g., a particular user device) may be paired with a particular vehicle or VDC subsystem at any particular time). A CarScore may then be calculated based on the total operation time of the vehicle (e.g., as may be stored in a CarProfile of the VMSP), but, because, the time of operation may be tracked for each one of one or more different users, the distinct impact on the CarScore by each operator user may be identified (e.g., the total CarScore may be broken down into any suitable data that may indicate the effect of each individual user operator on that total score). The VMSP may be operative to not only calculate a CarScore for each vehicle, but also to calculate a DriverScore for each individual user that may be based on operation of multiple vehicles and/or that may be a portion or the entirety of a CarScore for a particular vehicle (e.g., each user of a vehicle may have a DriverScore, and the DriverScore of the drivers of the vehicle may be a derivative of the total CarScore for that vehicle). The CarHub Connect application may provide a link between the vehicle diagnostics data of the CarScore and the CarHub product ecosystem. Integration between CarHub products may provide a way to connect user behaviors to the maintenance and buying and selling aspects of vehicle ownership. Some of the many features that may be enabled or otherwise facilitated by the VMSP of system 1 may be described in further detail herein. Quantitative driving behavior feedback may be provided by the VMSP for a particular driver or for all drivers of a vehicle. For example, drivers may be provided with a visual marker or otherwise to measure how well they are driving. The VMSP may be configured to determine and present forecasted increase and/or decrease in vehicle value to motivate a user to improve/maintain driving habits. Quantitative vehicle value assurance may be provided by the VMSP, such that a vehicle seeker can buy with confidence in the condition of the vehicle. Therefore, vehicle owners can sell a vehicle easier, without the need to determine the fair price or assess vehicle condition manually or through third party inspection.

The CarHub OBD device product (“CH-OBD”) of the VMSP may be provided by a VO subsystem directly, or by a VO subsystem via a VDC subsystem, and may request and/or collect any suitable vehicle diagnostic data or on-board diagnostic data (“OBD data”) from one or more control modules of vehicle 90 during use of vehicle 90. For example, the OBD product may be an on-board diagnostics device, which may be plugged into (e.g., installed) in an OBD-II port of a vehicle in order to monitor data from any suitable components of the vehicle (e.g., the Engine Control Unit (“ECU”) of the vehicle) as well as other data types that may be made available to the OBD protocol or otherwise. For example, the OBD device may send requests to the control module(s) of the vehicle for specific OBD-II PIDs (“on-board diagnostics parameter identifiers”). The CH-OBD may include a wireless communication module that may allow the CH-OBD to be communicatively coupled to (or include) a CarHub Connect app such that data may be stored on a VO subsystem and/or made available to VMS subsystem 10 for any suitable processing despite the mobile nature of the vehicle. The CH-OBD may provide quantifiable data for calculation of the CarScore, which may be available for storage and use in various CarHub products such as a CarProfile of a particular vehicle.

The OBD data can include engine error codes as well as any suitable raw data for vehicle performance. Through integration with MyCar and any suitable service providers, CarHub can diagnose vehicle problems based on the interpretation of engine error codes that may be cross-referenced with make/model configurations, as similar error codes may not universally correlate to the same maintenance problems between different make/models of vehicles. Information may be cross-referenced with user location and available automotive service centers in order to provide the recommended place to service a vehicle. This information may be shared with service providers directly, so that they may offer service quotes and compete for the business of the CarHub user (e.g., the platform may enable communication between third party enabling subsystems (e.g., one or more of subsystems 100j-1001) operated by maintenance service providers and the platform vehicle users such that a relationship between the two may be facilitated for more easily maintaining the health of the vehicle). Raw data can be used to calculate the CarScore and driving behavior of a vehicle user, which may integrate with Cartron results in order to determine the best vehicle make/model type for a unique user if that user were to seek another or additional vehicle. The OBD device may be operative to synchronize with an internal time keeping device in the vehicle, such as an internal clock, in order to check if the device has been active or inactive during the time the vehicle was previously in operation. Certain quantities may be checked against one another in order to estimate if the OBD device was used during the last time the vehicle was operated or not, as a way to measure compliance of device usage. For example, specific OBD data, such as fuel pressure data, can be used as a measure to determine if the vehicle had been driven without communicating OBD data to the VMSP (e.g., current fuel pressure OBD data received by the VMSP may be compared to the fuel pressure OBD data previously received by the VMSP to determine if there is a difference indicative of vehicle use between data collection instances). For example, if PID-0A is called, the Fuel Pressure OBD data may be returned, and can be compared to the last stored value before the vehicle was turned off. This value may be stored on the OBD device or on the CarHub Connect application or any other suitable data storage component of the VMSP (e.g., memory 13 of VMS subsystem 10). If these values differ by a significant amount, it can be assumed that the vehicle was operated without the OBD device installed or otherwise without OBD data being collected by the VMSP. Additionally, if odometer information is made available from a specific vehicle, it can be used directly to determine if the vehicle was used without OBD data being collected by the VMSP. A “confidence” or “accuracy” parameter may be included in the CarScore reporting in order to reflect the accuracy of the calculation based on such determinations.

The CarHub Connect (“CHC”) app may be any suitable application or resource that may centralize the collection of OBD data together with the CarHub customer experience, which may include Cartron, MyCar, Finance, and the Marketplace (e.g., buying/selling) products of the VMSP. The CHC may be operative to stream and retrieve data directly from the OBD device through a wired or wireless data connection, such as BLE, Wi-Fi, and associated wireless connection protocols and technologies, and/or the CHC may be running on a device or subsystem that may be operative to act as the OBD device (e.g., VDC subsystem 100d and/or VO subsystem 100a of FIG. 1B and/or VO subsystem 100b of FIG. 1C may be running at least a portion of a CHC app for enabling the OBD data to be accessed from the vehicle and then accessible to the VMSP). The CHC app can additionally modify the firmware of the OBD device as needed to perform software upgrades and/or to add functionality to the OBD device. Data from the OBD can be saved on the device with the CHC application and can additionally be sent directly to other CarHub products (e.g., via network 50 or otherwise). This data can then be used in different CarHub products, such as MyCar, CarScore, Cartron, and/or the like. The CHC app (e.g., a user portal to the system platform) may also connect to third party OBD devices or may access data directly from the vehicle's diagnostic system.

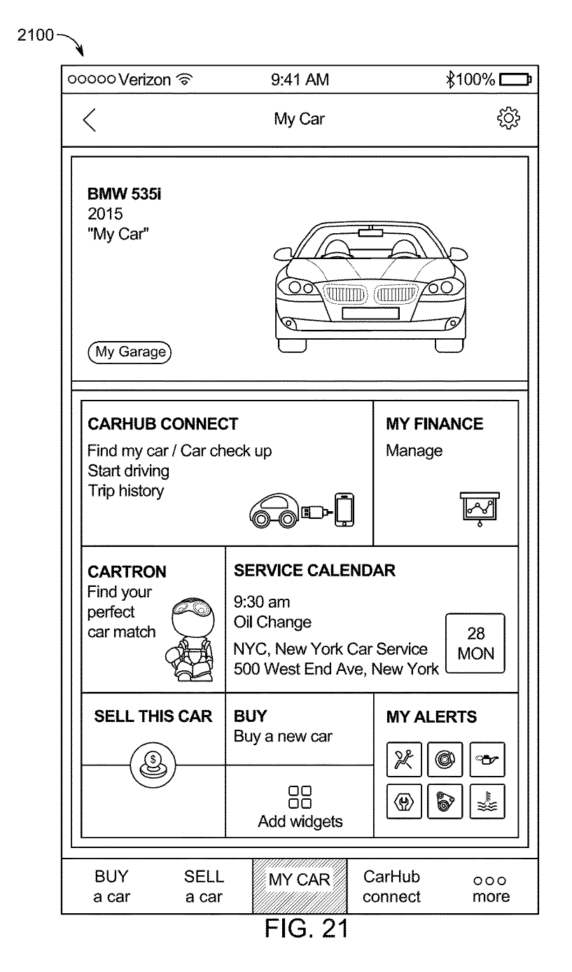

As shown by screens 2100-2400 of FIGS. 21-24, the CHC app may enable users to access the CarHub Product Ecosystem on their mobile device (e.g., smartphone) or any other suitable user subsystem (e.g., one of VO subsystems 100a-100c and/or one of VS subsystems 100g-100i). Data from the OBD device can be accessed through the CHC app and stored on the user subsystem as well as uploaded to a remote location (e.g., data server of the VMSP (e.g., to VMS subsystem 10 or an associated TPE subsystem (e.g., via network 50)). The Car Health (e.g., CarScore) of a particular vehicle that may be communicatively coupled to the user device that may be running the CHC app (e.g., the particular vehicle 90 whose one or more control modules 92 may be communicatively coupled to the user device (e.g., directly or via a VDC subsystem)) can be accessed by the CHC app. Such a CarScore may be calculated directly on the user subsystem with the CHC app based on any suitable data accessible to the CHC app (e.g., the OBD diagnostic data and data local to the user device running the CHC app). Alternatively, the user device and the CHC app may communicate certain diagnostic data or other vehicle specific data with a remote location (e.g., a data server of the VMSP (e.g., to VMS subsystem 10 or an associated TPE subsystem (e.g., via network 50)) to utilize remote processing capabilities or data to calculate such a CarScore. The CHC app may be enabled to use geo-location of the user subsystem running the CHC app (e.g., via any suitable sensor(s) 115 of the user subsystem or otherwise) to aid in the car maintenance and lifecycle process by connecting car needs to local maintenance providers. Alerts for new/used cars can be viewed on the user subsystem with the CHC app for optimal geo-location and connecting platform users to available test drives, used vehicle purchases, and/or the like.

At the center of the CHC app experience may be the MyCar product, which may integrate with and facilitate various aspects of the vehicle ownership cycle that are generally separate (e.g., buying, maintenance, selling, etc.). MyCar may be a central location for users to access information about vehicles they have registered on the CarHub platform, access information about CarHub rewards, use Cartron, and integrate with the buying and selling of vehicles on the CarHub platform and within the product ecosystem. From MyCar, users can see a summary of upcoming service needs for their registered vehicles, access Cartron, review their Finance situation, and access the MyGarage product.

As shown by screens 700-1100 of FIGS. 7-11, the platform may be operative to enable a user to register a vehicle with the platform. During the registration process, points may be acquired by a user for information provided by the user during registration and the points' value may be directly correlated to the value of the information given with respect to the CarHub business system, which may represent behavior teaching, occurring early in the relationship between CarHub and a user. Platform users may be taught that their actions are reciprocated with points value from CarHub, where the points earning behavior may carry through other CarHub products such as Cartron. As shown in FIGS. 7-11, a vehicle registration process may request various details about the vehicle, including the VIN, financial status, and condition of the vehicle. This information can be used directly or in the future in various ways, for example, to calculate a fair equity value of the vehicle, when combined with OBD data (e.g., via CarHub Connect) the projected equity value based on driver behavior, projected degradation of the value of the vehicle, and the like. This information can be used to sell the vehicle in the future, allowing integration with the My Sell Price, Make Me Buy, and Time To Sell products.

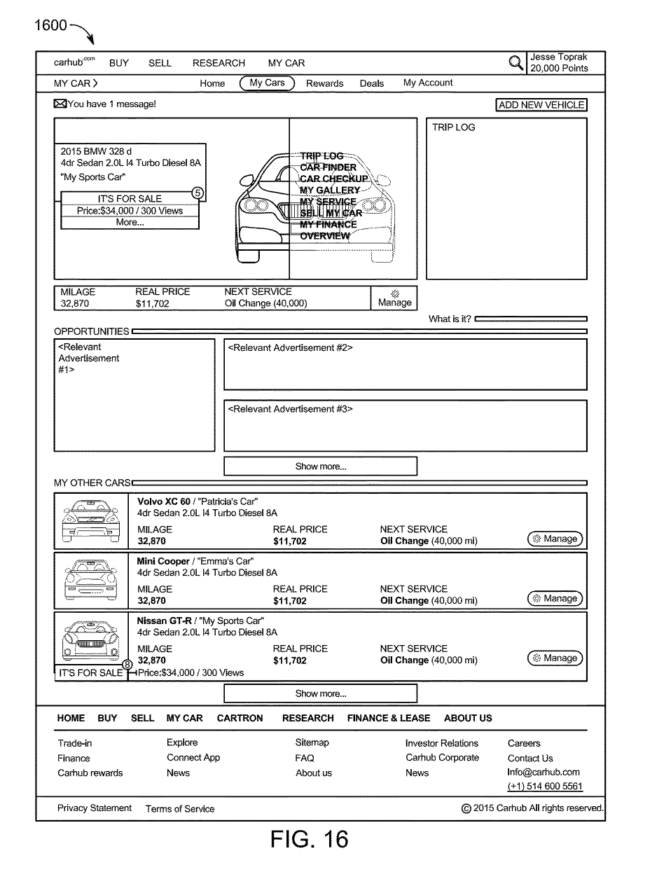

As shown by screens 1600-2000 of FIGS. 16-20, the MyCar product may provide a central overview of registered vehicles, deals, CarHub points, financing, Cartron access, vehicle alerts, upcoming maintenance events, and/or the like for a particular platform user. A detail overview of specific registered vehicles or of all the vehicles registered by a user can be presented. Planned maintenance events can be seen and service appointments or links to appointment services can be accessed, so that the life cycle of a vehicle or collection of vehicles may be maintained at a high level. Vehicle configurations can be saved and accessed with the MyCar product. Additionally or alternatively, the MyCar product may enable viewing alerts for vehicles of interest that may have recently come on the market on the platform (e.g., new/used vehicles of other platform users (e.g., individual users and business entity users (e.g., dealerships))). Alerts and saved configurations may integrate with the Cartron test profile of a user, so that assumptions on the desires and wants of a user may be refined over time, which may be integrated with a recommendation engine to improve CarHub products, rewards, and partner offerings.

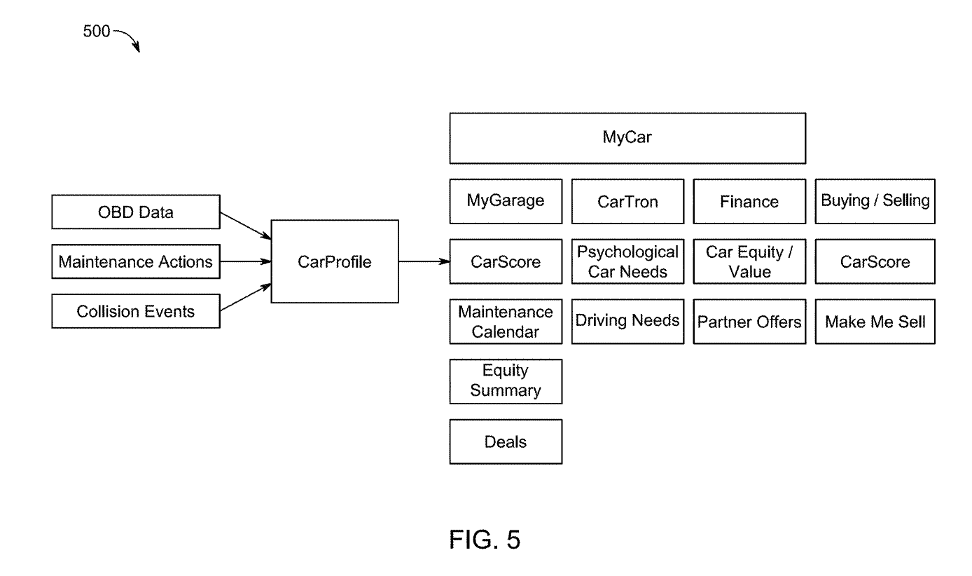

The CarScore may be a data profile that may be calculated from the OBD data (e.g., as collected in the CarHub Connect app) as well as, in some embodiments, from other parameters, such as vehicle maintenance actions (e.g., oil changes, engine tuning, etc.) that may be identified in any suitable manner. OBD data may report vehicle performance, as well as Malfunction Indicator Lamp (“MIL”) warnings. MIL warnings may be diagnosed by a service center to determine what repairs are needed for a vehicle. MIL warnings may be cleared by a service center after any appropriate repairs or services have been accomplished. Therefore, during the time that a MIL is active, the error code of the MIL may be recorded as OBD data by the VMSP (e.g., in the CarProfile), and therefore can be used in the CarScore calculation. For example, if an oil change MIL is active for a month, this may be a direct indication that the oil needs to be changed, but has not been done yet, and would negatively impact the CarScore. Collision detection can be accomplished through the integration of an Inertial Measurement Unit (“IMU”) or any other suitable sensor(s) 115 of a vehicle owner subsystem and/or of a vehicle data collector subsystem associated with a particular vehicle. For example, an IMU may include 3-axis accelerometer and 3-axis gyroscope sensors, which can track the magnitude, direction, and time of a critical impact, which may be indicative of a serious accident. A collision data record of the vehicle may be activated if a collision threshold is exceeded. For example, a side, frontal, or rear impact may be determined by the magnitude of acceleration or any other sensed data. A serious roll-over event may be detected as well by a gyroscope sensor. The seriousness of the accident may be recorded in the CarProfile and included in the CarScore calculation. Additionally, maintenance events, such as proof of body work or repairs, may be documented and uploaded by the user to the CarProfile, resulting in a positive impact on the CarScore calculation. The CarScore may be used to quantify and communicate the diagnostic state, or health of a vehicle. The CarScore may be calculated uniquely, and may be tied to a specific unique vehicle (e.g., using a VIN that may be registered with the VMSP (e.g., registered in a MyCar product of the CarHub platform)). The CarScore may be presented (e.g., displayed or enunciated aurally) as a number or other easily quantifiable and recognizable abstraction of the health of the vehicle (e.g., on a known scale, such as on a scale of 1-100) that may be used in various CarHub products. A representation between calculated CarScore and other CarHub products may be illustrated by diagram 500 of FIG. 5. For example, the calculation of the CarScore may be based directly on OBD data and/or maintenance history and/or any detected collision events, which may then be used in different parts of CarHub, including the buying/selling process of the Marketplace product, the Finance product for determining equity value and potential offers, the Cartron product for identifying the manner in which a user utilizes vehicles, and the MyGarage feature of the MyCar product for identifying maintenance events and maintenance calendar and equity summary. The CarProfile/CarScore and OBD data may be used to validate the results of a Cartron test. For example, if Cartron predicts that the user needs a car mainly for highway driving, but the CarProfile data shows that the user is primarily driving in the city, this can be used to recommend a different car for the user (e.g., a car that is more fuel efficient in a city driving environment (e.g., an electric car)).

The CarScore may be a quantifiable measure of the health of a vehicle, which may be highly influenced by driver behavior. A CarScore may take into account the vehicle diagnostic data, which may be continually monitored and updated while the vehicle is in operation, as well as any maintenance actions that may be taken by vehicle users and identified by the CHC app as well as any accident and damage events that may occur and be identified by the CHC app (e.g., via any coupled subsystem sensors or input data). Therefore, the CarScore may also relate to the monetary and equity value of a vehicle with regards to selling or when trading-in during a new vehicle buying process. A higher CarScore may be indicative of a healthier or better condition vehicle, when compared with a lower CarScore vehicle that may be indicative of a vehicle with poor health or that was used in a degrading manner.

A CarProfile can be shared with service centers or partners (e.g., TPE subsystems and/or VPS subsystem 10) in order to offer tailored services in the geographic area of the vehicle or owner (e.g., as may be determined by a GPS sensor or other location sensor of a VO subsystem of a VO of the vehicle or of the OBD device of the vehicle). A CarProfile can integrate with a used vehicle selling process and “My Sell Price” (“MSP”) feature of a vehicle commerce management (“VCM”) product of the VMSP in order to give security to a relevant party that the used vehicle is at a specific level of condition and function. This can accelerate the used vehicle buying and selling process as buyers can be assured of the vehicle life history and performance before seeing the vehicle in person or virtually. The CarScore can also be used as a way to provide a higher selling price or trade-in value before a buyer sees the vehicle, than a vehicle which does not have a CarScore associated with it. Therefore, the CarScore can provide an element of trust that relevant parties in a vehicle transaction may rely on to ensure that a transaction is being carried out efficiently and effectively.

The CarScore may be calculated at least based on the OBD data collected from a vehicle. The CarScore may be designed to provide an indication of the health of the vehicle, and may be used to communicate the health of a vehicle in order to increase the efficiency of the use and/or buying and selling process of new or used vehicles. For used-vehicle transactions, the CarScore may provide a quantifiable measure of the health and condition of the vehicle, which may thereby reduce the duration of, or better inform, the price negotiating process between a buyer and a seller. As described below, the CarScore can be used in the calculation of the RealPrice, in order to directly relate car health to the fair price of a vehicle in a certain condition.

During vehicle operation, different sets of OBD data may be collected, including, but not limited to, vehicle performance data and engine malfunction warning data. Performance data of a vehicle may be related to diagnostics information, such as oxygen levels, vehicle speed, temperature, and/or the like, and may be collected by the VMSP (e.g., by the CarHub Connect application and/or saved in the CarProfile for the vehicle). Performance may be gathered by issuing specific PIDs to the vehicle, and decoding the returned data packets. If a warning is triggered from the vehicle, an engine warning light (e.g., MIL) may be triggered automatically on a vehicle dashboard, and the error code may be reported as OBD data, which may be stored in the CarProfile. Environmental information related to the location of the vehicle can be tracked by the geo-location data collection capabilities of the CarHub Connect mobile application and/or any other suitable data source of the VMSP, so that any suitable factors, such as road conditions and/or weather and/or traffic and/or location, can be factored into the CarScore. For example, driving a vehicle in a cold climate where salt is used on roads can impact vehicle health more harshly than if the vehicle were operated in a location where environmental conditions are more mild.

Conceptually, a vehicle may be considered to be in perfect condition when it is in dealership possession. This may be associated with the best CarScore (e.g., a CarScore of 100 if a CarScore rating may be ranged between 1 and 100). The value of 100 may relatively reflect a perfect score, such as 100%, and can be easily interpreted by vehicle owners and prospective buyers. Once a vehicle leaves dealer possession and is taken over by a new owner, the health of the vehicle will start to degrade with normal usage, therefore vehicle condition may usually be related to total mileage. The CarScore calculation may be primarily based around three features: Degradation Slope, Events, and Time. While a vehicle may generally be owned by one individual, it may be operated by multiple drivers. Therefore, the CarHub Connect mobile application allows different users to “check-in” to a vehicle for operation purposes. The total OBD data may be stored and associated with a particular CarProfile associated with a particular vehicle, but the contribution of individual drivers can then be accounted for and associated with individual driver or operator or user accounts of the VMSP. The Degradation Slope (e.g., health degradation) feature of a CarScore calculation may be related to mileage covered (e.g., driven) by a vehicle as well as by the relative harshness of how the vehicle is operated (e.g., driven) by different users and/or driving conditions (e.g., weather, etc.). Specific driving habits, such as hard acceleration and braking, may be reflected in a more negative slope than if more gentle driving habits are employed by individual drivers. An Event of the Event feature of a CarScore calculation may be defined as an action taken by a vehicle operator and/or a vehicle owner that may cause an automatic recalculation of the CarScore (e.g., a maintenance need event and/or a maintenance resolution event). Additionally, an Event may be a collision event, which may result in vehicle damage that requires repair. For example, if a MIL is triggered, the error code may be made available and the type of required repair may be determined and used to define an Event, after which it may then be the responsibility of the vehicle owner to get the vehicle serviced. The Degradation Slope may increase during this time until the vehicle has been serviced (e.g., during the time between a maintenance need event and an associated maintenance resolution event). Once the vehicle has been serviced and the MIL turned off by the service technician, the CarScore may automatically increase to reflect that the vehicle has undergone the required maintenance. The Time feature of a CarScore calculation may be a function of CarScore indicating how the Degradation Slope and Events have occurred over the life of the vehicle. Additionally, Time may be used in order to differentiate between when specific drivers have operated a vehicle.

As shown by diagram 4000 of FIG. 40, for example, the VMSP (e.g., CarHub Connect app) may collect OBD data (e.g., PID/vehicle performance data, MIL/maintenance needs and events, and/or accident event data (e.g., IMU/collision event data)). OBD data and any other suitable data, such as time data, location data, user/operator data, weather data, traffic data, road type/condition data, any other suitable vehicle environment data, accident event data, and/or the like, which may be collected by any suitable VMSP subsystem associated with the vehicle (e.g., by a CarHub Connect app of a vehicle operator) may be combined with OBD data and processed by the VMSP to provide a CarProfile for the vehicle and/or a CarScore for the vehicle and/or a DriverScore for a particular operator. As shown, certain CarProfile data may be used in conjunction with Cartron to determine a vehicle recommendation. Performance data, such as acceleration profile data, speed profile data, braking profile data, fuel efficiency data, mileage data, O2 sensor data, and/or the like for a certain vehicle and/or operator, and/or direct service needs data (e.g., OEM error decoding data) may be provided as at least a portion of CarProfile data. Quantitative history of such vehicle performance data may be analyzed by the VMSP to assess the actual vehicle operation behavior of a user operator and the VMSP may compare such behavior with a qualitative assessment of user needs from a Cartron profile to determine whether the user's vehicle needs from the Cartron profile match the user's actual operation behavior. If the user's Cartron profile needs match the user's actual operation behavior, then the Cartron profile prediction may be reinforced and maintained. However, if the user's Cartron profile needs do not match the user's actual operation behavior, then the Cartron profile may be updated to suggest a different vehicle type, which may facilitate the VMSP to suggest one or more particular vehicles in the VMSP marketplace. As also shown in FIG. 40, a CarScore may be calculated by the VMSP based on the CarProfile and other suitable data, such as features that may include Health Degradation, Events (e.g., accident/collision events, maintenance need events, maintenance resolution events, etc.), and/or Time. The current CarScore for a vehicle may be used by the VMSP to affect various products of the VMSP ecosystem, such as RealPrice (e.g., alone or in combination with national car sale listings, third party sale listings, and/or sales history within the VMSP). Future trends of the CarScore may be utilized in combination with a current RealPrice to forecast a future RealPrice of the vehicle, which may affect various products of the VMSP ecosystem, such as MyFinance, Cartron, and/or Marketplace. As also shown, the VMSP may be operative to determine a DriverScore or OperatorScore for each one of multiple operators of a vehicle (or of multiple vehicles). For example, as shown, DriverScore 1 for a Driver 1 and DriverScore 2 for a Driver 2 and DriverScore 3 for a Driver 3 may combine to determine the CarScore for a vehicle. A gradual declining health degradation slope may lower the CarScore over time, while an accident event may result in a sharp decrease in CarScore, while repairs and/or tune-ups may result in a sharp increase in CarScore.

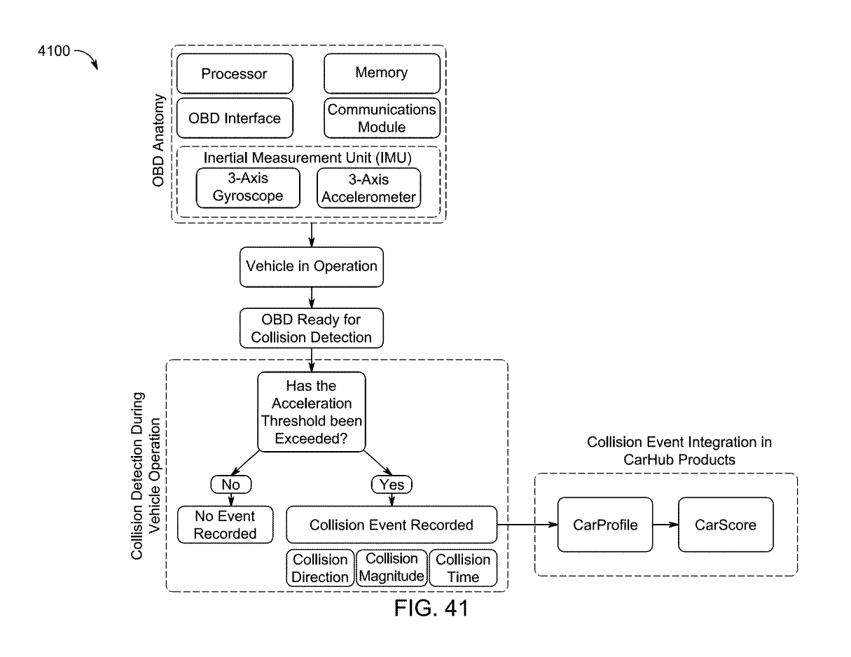

As mentioned, any suitable entity or entities of the VMSP system may include one or more suitable motion sensors (e.g., an IMU sensor) and/or any other suitable sensor(s) that may be used to detect collisions and/or other accident events of a vehicle (e.g., one or more sensors 115 of a vehicle owner subsystem and/or of a vehicle data collector subsystem and/or of the vehicle itself). An OBD protocol may be designed to allow vehicle performance data and error messages to be referenced from the vehicle as standard data communication, while the integration of an IMU or other sensor(s) may allow for motion monitoring. An IMU may include a 3-axis gyroscope sensor and a 3-axis acceleration sensor. As shown by diagram 4100 of FIG. 41, for example, while the vehicle is in operation (or perhaps even when the vehicle is not being actively operated), the IMU may monitor the relative changes in acceleration of the vehicle in order to determine whether or not a collision or other accident event has occurred. This may be accomplished by defining one or more acceleration thresholds, which if exceeded, may trigger data collection and/or saving of an accident event. Then, during the accident event, the magnitude, direction, and/or time of sensor data may be collected. This data may be processed by the VMSP to enable determination of differentiation between front, rear, or side impacts, for example. A collision or accident event can then be recorded in the CarProfile and integrated into the CarScore calculation for the vehicle.

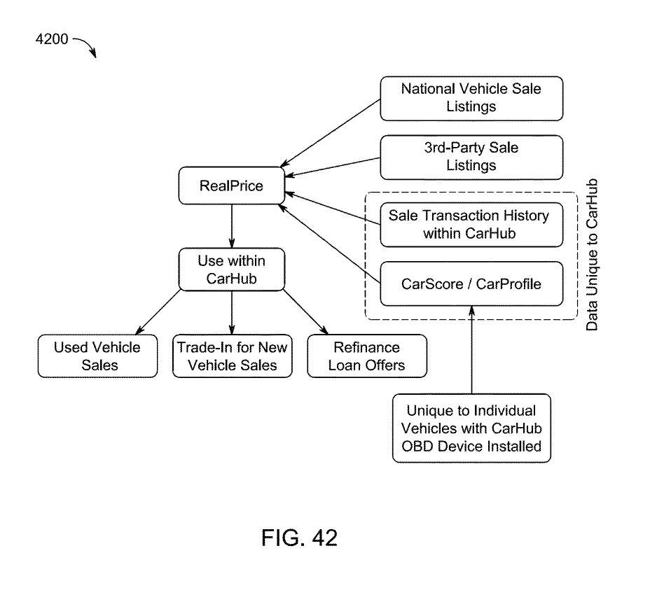

The “RealPrice” of a vehicle, as may be defined by the VMSP, may be a valuation of the monetary value of the vehicle being sold or which could be sold on the open market. After a new vehicle is bought and leaves the dealership lot, it may be determined to have a RealPrice value below the sticker price, and can be sold as a used vehicle. Determining the fair price for a used vehicle may be difficult to buyers and sellers to agree upon, which then defines a significant part of the used-vehicle transaction process. By defining a RealPrice for a vehicle, the VMSP may make it easier for a used-vehicle transaction to proceed, for example, by reducing the total transaction time and making the process easier for both the buyer and the seller. As shown by diagram 4200 of FIG. 42, The RealPrice may be calculated based on four primary data sets: national vehicle sales history (e.g., for the particular vehicle type), third party for-sale listings (e.g., for the particular vehicle type), sales histories within the CarHub marketplace (e.g., for the particular vehicle type), and the CarScore/CarProfile information (e.g., for the particular vehicle type and/or the particular vehicle itself). The combination of these data sets may allow the RealPrice to be calculated from a comparison to the actual sale prices of a particular vehicle make/model/year combination, but also may allow for fine-tuning of the RealPrice by taking into account the diagnostic data and vehicle health by using the CarScore and sales data that may only be available within the CarHub marketplace. The RealPrice valuation for a vehicle may allow owners and prospective buyers to have an unbiased measure of the monetary value of a vehicle that may be offered for sale. Additionally, the RealPrice may be used in different CarHub or third party products to offer tailored financial services, such as loan refinancing. The RealPrice may also be used in the purchase of a new vehicle, by defining the trade-in value of a vehicle against the new price of the vehicle. This may allow prospective buyers to negotiate a trade-in value higher than an average trade-in value due to the tracking of the RealPrice and CarScore information within the CarHub product ecosystem.

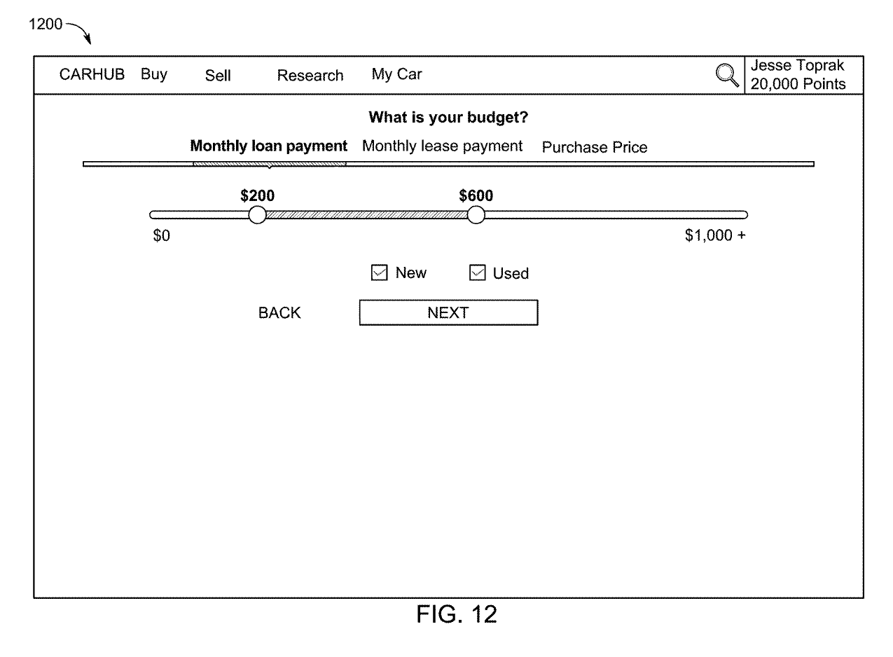

Cartron may be an application or platform product that may present a user with questions or any other suitable questionnaire or data collection interface, and, based upon the answers collected, may provide a profile of the user that may quantify the preferences of the user with regards to needs of a vehicle as well as their needs for specific vehicle types. The output of Cartron may integrate as an input to a CarHub Car Recommendation Engine (“CRE”) of the VMSP in order to provide the user with vehicles that may fit the user's needs and financial situation. Cartron may be accessed through the MyCar section of the CarHub product, and can also be accessed through the buying process of new and used cars on the CarHub platform (e.g., via the CHC app). For example, as shown by screens 1200-1500 of FIGS. 12-15, a Cartron test may include a collection of quantitative and qualitative questions for users, to which the answers may be used to create a profile of the needs of a user with respect to the ideal vehicle for them to drive (e.g., answers indicative of budget, preferred vehicle styles, values, financing, car age, and/or the like). The Cartron results may be combined with driving behavior quantified by the OBD data (e.g., via CarHub Connect) to validate that a particular vehicle fits to a particular user/driver. The Cartron results may also integrate directly with a vehicle configurator and new/used inventory in the geographic location of the user, as well as with vehicle alerts (e.g., to notify when vehicles are available in the future). Cartron can be accessed during the vehicle configuration process (e.g., a new/used vehicle search) in order to help users understand their vehicle needs. Cartron may help to remove/overcome the burden of searching for a vehicle configuration, in particular for users who do not have a defined concept of what they need in a vehicle. Cartron can speed up the buying process by addressing the burden of searching through vehicles and making decisions on search criteria which may be needed before a vehicle configuration can be proposed.

As shown by schematics 3600-3900 of FIGS. 36-39, a multi-level vehicle recommendation Cartron product may be provided that combines brand perception, personality, personal values, vehicle specifications, options, and/or vehicle ratings into a unified system. Various variables may be used in the model of Cartron. For example, various vehicle feature variables may include, but are not limited to, safety, convenience, style, power, handling, family friendliness, weather handling, eco-friendliness, technology, cargo capacity, practicality, and/or the like. As another example, various personality variables may include, but are not limited to, masculinity, femininity, conscientiousness, extraversion, introversion, agreeableness, openness to experience, and/or the like. As another example, various values variables may include, but are not limited to, tradition, stimulation, power, achievement, benevolence, universalism, loyalty, authoritarianism, and/or the like. One, some, or all of these may be predictive of vehicle preferences. This and other available data on vehicle specifications (e.g., from any suitable third party subsystems with vehicle specifications and ratings and reviews from any suitable vehicle rating and review online resources) may be used to carry out Cartron. For brand prediction, collaborative filtering may leverage particular (e.g., proprietary) surveys of consumers to allow Cartron to understand the brands that a consumer who matches on personality and values variables would be most likely to be interested in. Brand perception data, user personality variables and user personal values variables may be combined to determine a brand recommendation. For model prediction, semantic analysis of online model ratings may allow Cartron to rate each vehicle model on specific features. Collaborative filtering may leverage particular (e.g., proprietary) survey data on how personality and values variables interact with model features to allow Cartron to predict the features that consumers likely desire in a vehicle. Cross referencing these variables may enable Carton to make specific vehicle model recommendations. For example, data from model ratings along with model feature ratings, in combination with user personality variables and user personal values variables and car feature preference data for preferred model features, may be used to determine a model recommendation. For trim prediction, trim specifications and any suitable options may enable Cartron to rate each car trim on specific features. Collaborative filtering may leverage particular (e.g., proprietary) survey data on how personality and values variables interact with vehicle features to allow Cartron to predict the features that consumers likely desire in a vehicle. Cross referencing these variables may enable Cartron to make specific car trim recommendations. For example, data from trim specifications along with trim feature ratings, in combination with user personality variable(s) and/or user personal values variable(s) and car feature preference data to provide for preferred trim features, may be used to determine a trim recommendation. Then, brand recommendation, model recommendation, and trim recommendation may be combined to provide an overall recommendation score for each vehicle specific to each user and information for at least one top scoring vehicle of a user may be provided to that user for recommending a vehicle type for potential purchase. A CarProfile may include vehicle performance data for the vehicle, which may be used to create profiles for driving severity, fuel efficiency, and/or the like. Then, CarScore may be used in conjunction with RealPrice to predict a decrease of vehicle value in the future. This system may predict how much value (e.g., resale value and/or trade-in value) the user may be forecasted to lose based on their driving behavior (e.g., a user has high mileage, hard acceleration, and/or hard braking behavior). It may be beneficial for a certain user to own a certain vehicle type based on the user's usage performance, or to buy a new vehicle more often. For example, it may be beneficial for users who are hard on their vehicle to sell and obtain a new vehicle more frequently rather than using a vehicle such that it's RealPrice may degrade too quickly (e.g., as compared to a user who has a more gently deriving habit). At the same time, Cartron may help to define the needs of the users, such as needing a family-sized vehicle, for example. This may be essential for filtering car recommendations so that the user may receive car recommendations that fit their lifestyle, financial, and emotional needs.

Any suitable portal may be used by any suitable user to access any suitable products of the VMSP. For example, the CHC app may provide access to a collection of any suitable online or web-based products that may be accessible via any user subsystem that may be running the CHC app. The CHC app may define the front-end user experience, which may include the buying and selling of vehicles as well as management of the ownership experience. This may allow for the total lifecycle of a vehicle to be managed and financially optimized for a user of the CarHub product ecosystem. Integrated with the CHC app may be the CarHub Rewards System (“CRS”), which may define a method or environment for users to earn points (e.g., as a reward for any suitable interaction with the platform (e.g., leaving a review of a vehicle or a third party, etc.) and exchange such points for services of the platform, which may help to maintain the equity value of a vehicle registered in the CarHub product ecosystem (e.g., maintenance events at third party maintenance service providers). Key products in the CHC app may include MyCar, the CarHub Rewards System, My Sell Price, and the Marketplace.

Certain deals may be offered by the platform to one or more suitable users based on any suitable situation, such as user needs, user location, user financial status, user demographics, or the like. Such deals may be made on a local, national, or international level. Deals may be tied to the specific needs established through Cartron and evaluating the CarHealth and CarProfile performance history. The access to deals may be related to helping to maintain or improve the RealPrice of the vehicle. This might include, for example, offering an oil change at the correct time to a user of a vehicle (e.g., based on oil change OBD data) so that the vehicle may be kept in the best condition possible. This may benefit owners, sellers, and buyers of used vehicles.

The CarHub Rewards System (“CHRS”) may be a product for rewarding users for product interactions in the CarHub ecosystem. CHRS may be based on a points earning system, where points may be earned by users based on specific interactions and tasks completed in relation to CarHub products, such as registering their vehicle on the platform (e.g., using a verified VIN), completing a Cartron test, using the My Sell Price product, and/or various other interactions. Points may be earned and saved to a platform account of the user. Points can be exchanged for any suitable rewards, such as for a CarHub OBD device, and/or for services related to maintenance needs of a registered vehicle (e.g., maintenance service provider service that may help increase a CarScore of the user's vehicle), and/or other rewards may be organized together with approved partners and TPE subsystems of the platform. In this way, increased user interaction with the CarHub product ecosystem may directly increase the points a user earns, and, due to the exchange for maintenance services with partner companies, may have a direct positive impact on maintaining the condition and resale value of vehicles registered with CarHub. The interaction mechanics of receiving points may entail automatic confirmation of the increased points directly after completing an applicable platform interaction. In this way, the behavior may be instilled in, or learned by, users that platform interactions are rewarded with increased points. The relative amount of points earned per interaction may be based on the relative value of the interaction. For example, providing the VIN when registering a vehicle may be more valuable than posting an image of a vehicle or writing a short review.

The CHRS may extend from certain platform interactions, such as vehicle registration, to simple interactions, including User Generated Content (“UGC”) on the platform. Users may be able to create different types of UGC including, but not limited to, extended car reviews, posting pictures of interacting with their vehicle, short written updates on their vehicle ownership experiences and/or their platform experiences, sharing content on social media channels, and/or the like. As UGC may be tied to the profile of the user or registered vehicle, it may be possible to connect UGC to specific vehicle make/model combinations. In this way, UGC may provide a wealth of information for potential vehicle buyers, both for new as well as used vehicle models. UGC may act in a similar way to positively influence the vehicle buying process as user review content may help to increase the buying of a product. Products that have a story or review tied to them are often proven to sell at a higher rate than products which have no description or review in an online buying environment. Additionally, story content about a specific product can increase the perceived value of a product. The combination of CHRS and UGC may create an economic cycle between product interaction, rewards, and vehicle health, such that the buying/selling and maintenance of vehicles can be done in a fluid manner. The UGC on specific vehicle make/model combinations can increase the value of those used vehicles given that the story of those vehicles can be told through UGC of specific users.

MyGarage may be an application that may track the lifecycle of specific registered vehicles of users. MyGarage may provide a detailed interface for each registered vehicle (e.g., as may be platform verified by VIN), and for expanded services through external partners (e.g., TPE subsystems). The CarScore for each vehicle may be presented by MyGarage in order to inform users on the health of their vehicle. Information may be provided in case the CarScore decreases in order to educate the driver on how to increase the CarScore in the future through driving actions which may impart less wear and tear on the vehicle. For example, accelerating in an even manner, braking more evenly, and/or the like may be suggested by MyGarage based on CarScore calculation and/or analysis by the platform. A key benefit of using the CarHub product ecosystem may be to maintain the equity value of each registered vehicle. Therefore, through MyGarage, users can see upcoming service needs, such as oil changes and brake checks, as well as be alerted about more serious issues that may be reported by the OBD device.

Vehicle maintenance needs may be identified through the OBD data alone or in combination with other accessible data regarding the vehicle (e.g., from third party subsystems with data indicative of maintenance requirements of certain models of vehicles) and by time-based recommendations, which may historically be known for different car types. Third party service providers for maintenance needs can be recommended based on maintenance need and the geographic location of the user and/or vehicle, thereby allowing easy maintenance of the vehicle. In turn, regular maintenance of the vehicle may sustain the condition of the vehicle over the ownership cycle and may provide value to maintenance service providers. This information can then be used to recommend nearby vehicle service centers. In this way, the overall condition of the vehicle may be maintained at a level higher than normal for a vehicle owner who is not constantly checking the condition of their vehicle, or does not know how to maintain their vehicle. Location-based service center recommendations may be presented along with the service need notifications (e.g., on the CHC app). This may allow users to book service center appointments in a short amount of time after being made aware of service needs. This may reduce the burden of a user having to search for service centers in a particular area of relevance to the vehicle, and as a consequence may lead to maintenance issues being addressed sooner than if the MyGarage were not being used by the user. The maintenance needs of a vehicle may be fully or partially paid for by exchanging CarHub Points that the user may have acquired through interaction with the CarHub ecosystem. As service needs are addressed sooner, the resale value of the vehicle can be maintained at a higher level than if the lifecycle management of CarHub was not being used.

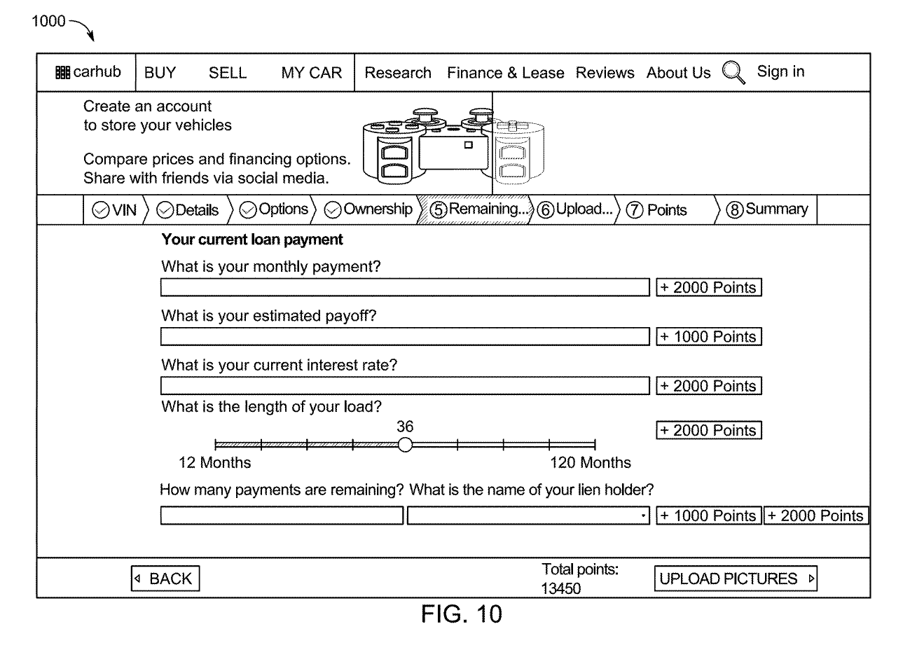

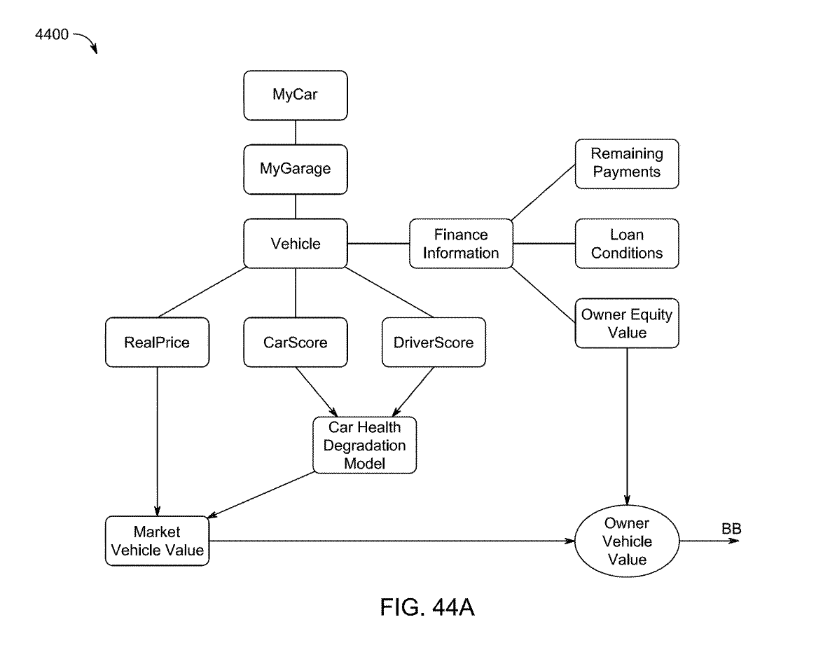

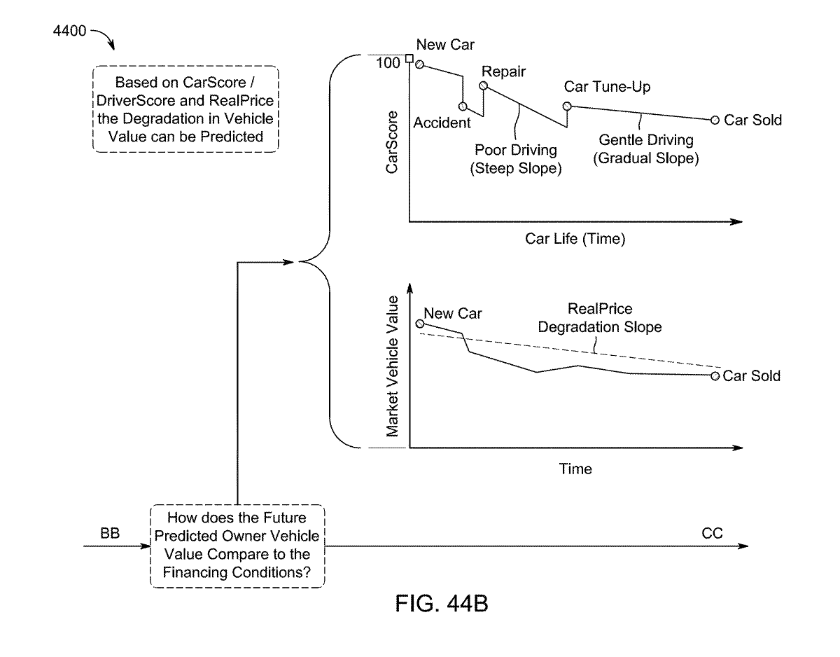

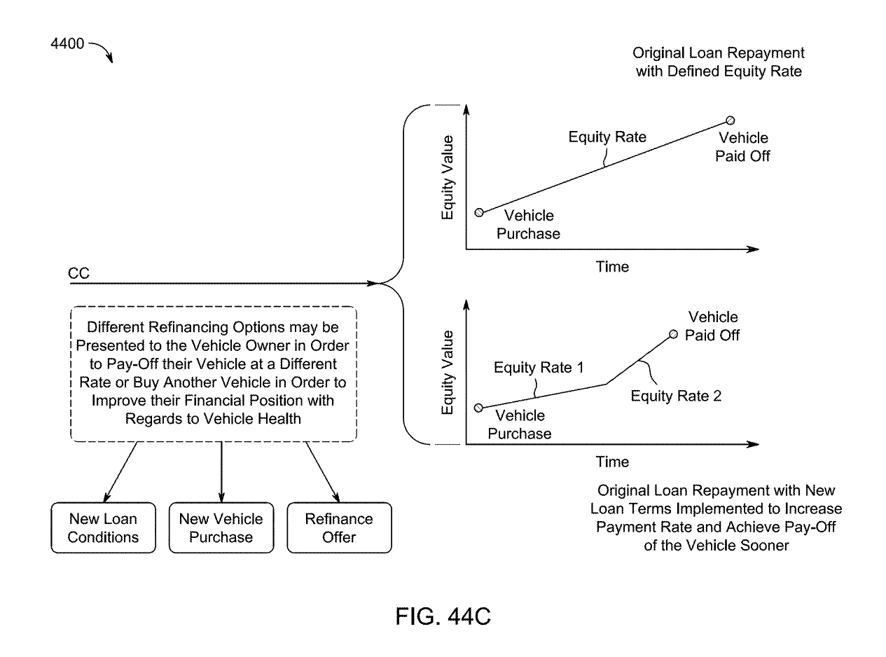

The Finance product, as may be accessed through the MyCar product, may be operative to track the financing state of platform-registered vehicles. Financial information on lease and loan payments and terms can be entered by users in order to track the remaining payments for a vehicle. Additionally, when combined with information on the car health and age, information from the finance product can be used to recommend refinancing options with third party partner companies and service providers. During the vehicle registration process, a user may be motivated to add information on the financial state of their vehicle, which may establish the financial state of the VIN verified vehicle, where such financial information may be used by the VMSP to determine when a vehicle owner should be offered refinancing in such a way to benefit the vehicle owner and aid in the management of the ownership cycle of the vehicle. As shown by screen 1000 of FIG. 10, for example, such financial information may include, but is not limited to, monthly payment amount, estimated payoff, current interest rate, length of the loan, number of payments remaining, name of lien holder, and the like. As shown by diagram 4400 of FIGS. 44A-44C, any vehicle in the MyGarage may be analyzed to provide an “Owner Vehicle Value,” which may be calculated by taking into account “Market Vehicle Value,” “Owner Equity Value,” and/or any other suitable data. Owner Equity value may be determined based on the current state of loan repayments, as may be determined from the financial information. The Market Vehicle Value may be determined based on a Car Health Degradation Model and the RealPrice of the vehicle. The RealPrice may include regional and local used market valuations for a particular make/model vehicle definition, which may be adjusted by a Car Health Degradation Model, which may be determined based on the CarScore and/or one or more DriverScores for the vehicle. The Owner Vehicle value may be the Market Vehicle Value as adjusted by the Owner Equity Value. Depending on various factors, which may include the rate of Owner Vehicle Value, which may generally be a linear positive increase based on fixed monthly repayments of a loan, and local market factors, it may be financially beneficially to the vehicle owner to buy a new or used vehicle instead of keeping the same vehicle at the current loan conditions. It may also be beneficial to repay the loan sooner so that the vehicle can be sold in good condition. For example, as shown, the VMSP may be configured to determine how a future Predicted Owner Vehicle Value (e.g., a calculation based on RealPrice and CarScore/DriverScore(s) to predict degradation in vehicle value) may compare to the current financing conditions, such that different refinancing options may be automatically presented to the vehicle owner in order to pay off their vehicle at a different rate and/or buy another vehicle in order to improve their financial position (e.g., with respect to vehicle health). For example, if a future Predicted Owner Vehicle Value decreases at a certain rate, then the equity value of the vehicle may be low compared to the loan payments used to reach a certain equity value in the future, and, in such a situation, it may be automatically determined by the VMSP that refinancing may benefit the vehicle owner in order to decrease the time needed to pay off the vehicle or it may be automatically determined by the VMSP to be more beneficial to buy a new vehicle and retain a higher overall vehicle equity value and place the owner in a better financial position than if they were to stay in their current loan repayment agreement. In such a circumstance, new offers for loan, lease, or refinancing may be offered by the VMSP in order to provide the vehicle owner with options in keeping the owner in the best financial position with respect to the equity value and future predicted Owner Vehicle Value of the vehicle. For example, if an owner's vehicle has a CarScore which is decreasing and/or predicted to decrease at a very gradual rate, it may be more beneficial to refinance in order to have a longer repayment term. Therefore, based on the driving behavior of the user (e.g., including miles driven per year and/or the average car ownership duration), it may be automatically determined by the VMSP to be most beneficial for the vehicle owner to lease their next vehicle instead of buying via loan financing. For example, if a user is routinely replacing vehicles every 3 years and drives less than 15,000 miles per year, the financing system of the VMSP may be configured to automatically recommend that the user investigate leasing options and offers.

The Marketplace product of the platform may be provided in order to aid a user in the process of buying and selling a vehicle at the best time possible. To that end, a vehicle commerce management (“VCM”) feature of the platform may be provided that may be operative to provide alert and price setting options to a user, which may include a Time To Buy (“TTB”) option, a Time To Sell (“TTS”) option, and a My Sell Price (“MSP”) option. The CarHub platform may be configured to allow users to be able to buy and sell vehicles at an optimal time given the lifecycle of a particular vehicle, which may be monitored by the CarHub Connect and OBD products, as well as the financial state of the vehicle, and the needs of the user (e.g., as may be determined from Cartron). Users may be provided by the platform with the ability to add information in the vehicle registration process that may be related to the loan and lease status of the car. This, combined with the CarScore and market needs, can provide valuable information on when a vehicle is most valuable to sell for the greatest financial benefit to the specific vehicle owner. This may take into account the remaining lease or loan payments, combined with the trade-in value, current dealership car offers, average used car sale prices, and the like.

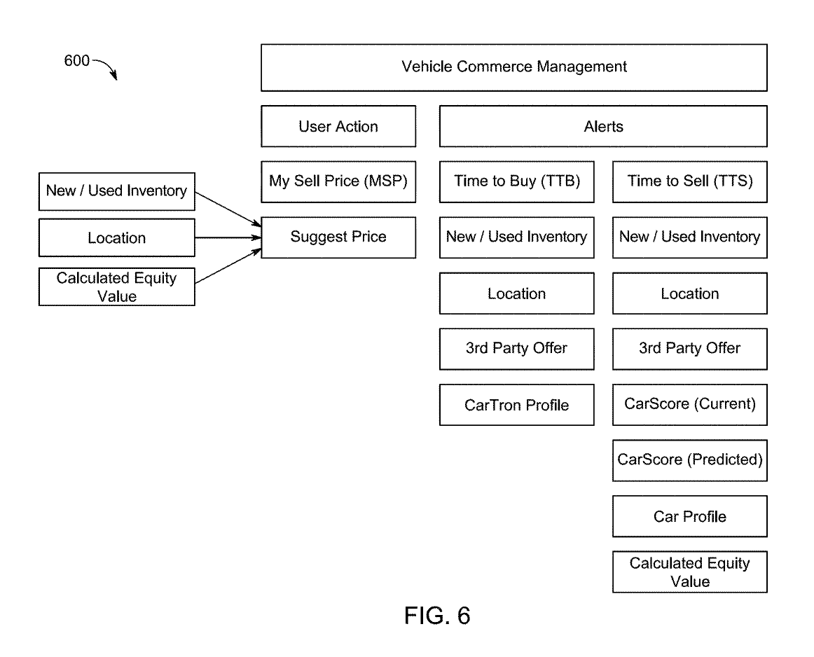

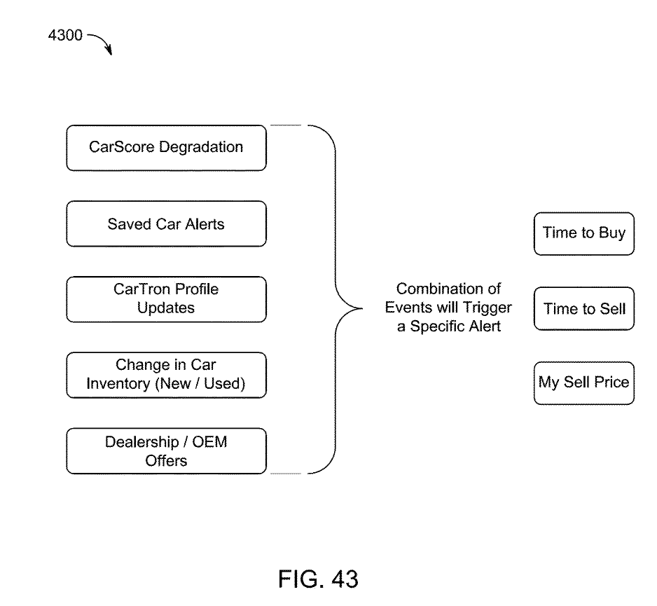

The features of the VCM product may be based on various inputs from inside and outside of the CarHub product ecosystem, as shown by diagram 600 of FIG. 6, which may provide an overview of the vehicle commerce alerts and action options including MSP, TTB, and TTS. For example, the combination of CarScore and associated data may provide confidence in the value price of the vehicle, and as a system may reduce barriers that potential sellers may face when deciding to sell their vehicle. By reducing those barriers, the VCM product can increase the number of available vehicles for a given used vehicle market where a user lives, or at a national level. As shown by diagram 4300 of FIG. 43, the various alert and price setting options (e.g., Time To Buy, Time To Sell, My Sell Price, etc.) that may be presented to a user may be determined by the VCM based on analysis of data from any suitable combination of events, including, but not limited to, CarScore (e.g., CarScore degradation), saved vehicle alerts for the user, Cartron profile updates, change in vehicle inventory (e.g., new and/or used vehicle inventory accessible by the VMSP), dealership/original equipment manufacturer (“OEM”) offers, and/or the like.

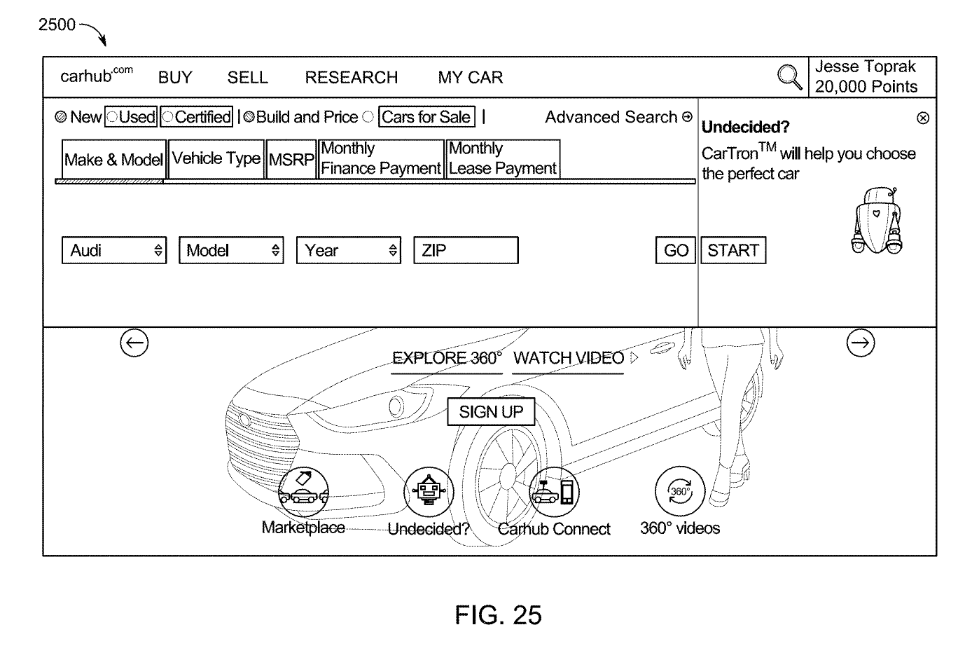

The Time To Buy option may be an alert system that may notify a user that it is a good time to buy a vehicle. TTB may be connected to a new or used vehicle configuration, specifically configurations that have been saved in the MyCar section of CarHub. The input criteria for TTB may ideally connected with user profile information provided by Cartron and additionally from the vehicle marketplace, so that the available price of a TTB vehicle may be tracked from dealerships and/or used car listings. A TTB alert may provide a user with information on where to buy the desired vehicle configuration, ideally based on their geographic location and financial status, which may be connected to the information contained in the Finance product, such as remaining payments left on a vehicle loan or number of lease payments left for the vehicle currently used by the user. As shown by screens 2500-3000 of FIGS. 25-30, the Marketplace product of the platform may provide a user with the ability to configure a new vehicle search for potential purchase using any suitable information, including, but not limited to, make and/or model, vehicle type, a manufacturer's suggested retail price (“MSRP”), platform suggested value, CarScore, finance payment information, lease payment information, vehicle location, Cartron recommendations, and/or the like. For example, Time To Buy might be triggered if the CarScore is determined to be degrading too quickly, which may indicate to the user(s) that it is operating the vehicle in a way that will significantly decrease the life-span and/or CarScore of their vehicle.

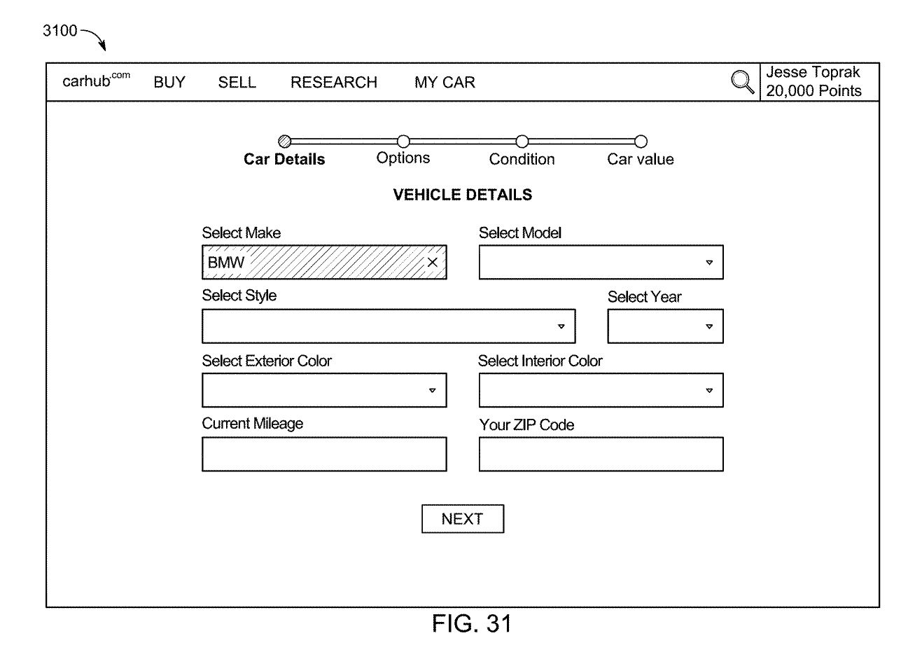

The Time To Sell option may be an alert system that may notify a user that it is a good time to sell their vehicle. The triggering of TTS may be related to the financial status of the current vehicle the user has, as well as the inventory of new and/or used vehicles in the location of the user. Additionally, the current vehicle health (e.g., as may be quantified by CarScore), as well as projected health (e.g., based on user driving behavior) may be used in determining a customized TTS alert for different users. Therefore, users with different driving behaviors may have different TTS alerts, since their driving styles may impact the vehicle health in different ways and necessitate different ownership lengths in order to be in the best financial position with regards to their current and project vehicle equity values. As shown by screens 3100-3500 of FIGS. 31-35, the Marketplace product of the platform may provide a user with the ability to configure a used vehicle in order to value the vehicle or generate data for selling or trading in the vehicle using any suitable information, including, but not limited to, make and/or model, vehicle type, vehicle color, vehicle mileage, any other suitable characteristics of the particular vehicle, a manufacturer's suggested retail price (“MSRP”), platform suggested value, CarScore, finance payment information, lease payment information, vehicle location, Cartron recommendations, and/or the like. Suggested value may differ depending on whether suggested value is for sale to a private party or to a dealer. For example, in used car sales, the highest sale price may be found between private parties (e.g., a buyer and a seller), while, generally, the price a dealer may offer to buy a used car for may be lower than if the seller sells to a private buyer. A dealership might also offer to buy the car without seeing it first, but at a fixed price. A goal of the VMSP may be to ensure a higher selling price for a vehicle, at a level as high as or higher than a private selling transaction, but with the efficiency of a dealership fixed buying price. For example, Time To Sell might be triggered if a better vehicle for the user (e.g., as determined by Cartron/driving profile) comes onto the market, either as new dealer inventory or as a used car, that may or may not be related to the geographic location of the user.

The My Sell Price option may be a platform method to allow users to make their vehicle available for sale as a used vehicle if a defined threshold is reached for the selling price. Due to the ability of the CarHub platform to collect and saves particular data about a particular vehicle (e.g., images, health, and performance data, etc.), registered vehicles may already have information about the vehicle in the platform, such as the VIN, mileage, and associated information that may be generally required in order to sell a used vehicle. Some or much of this information may be quantified in the CarScore, which may then be listed alongside the vehicle for sale. To use MSP, a user may select the MSP option, and with one selection interaction, a desired vehicle may be placed in the available inventory of the used vehicle database of the platform along with its CarScore and other pertinent information. For example, once a particular sell price may be defined by a user for a vehicle, the My Sell Price may automatically place the vehicle directly in the used car inventory of the VMSP if a buyer interest or need for such a vehicle is established by the VMSP for another user (e.g., if they have created an alert or if Cartron recommends that vehicle type).

The Marketplace product may allow registered as well as non-registered users of the platform to search for new and used vehicles as well as categories of vehicles, such as certified pre-owned (“CPO”) vehicles. Users can search through listed vehicles or build a custom vehicle configuration (e.g., based on make/model) using a vehicle configurator. For new and CPO vehicles, based on the location of the user, the available dealership inventory may be displayed and a user can enter the finance process in order to apply for a loan or lease as a to trade-in their vehicle or to buy a new vehicle based on their available dealer price. Similarly, used for-sale vehicles can be geo-located around the user to facilitate sales.

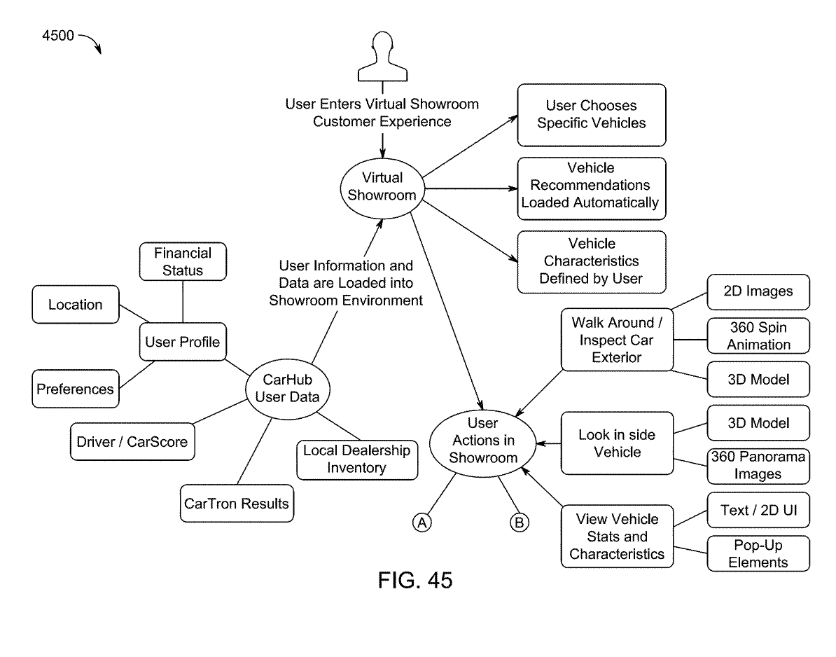

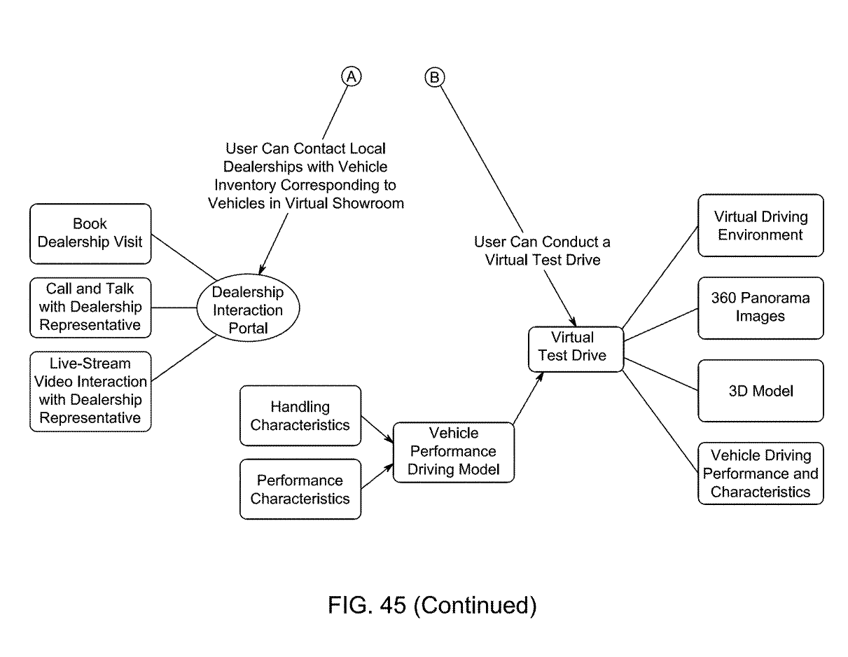

As mentioned, one or more subsystems 100 (e.g., a vehicle owner subsystem and/or a vehicle seeker subsystem) may include a virtual reality device (e.g., any suitable head mounted wearable display device) that may be operative to present data to a user in an immersive manner. As shown by diagram 4500 of FIG. 45, for example, the VMSP may be operative to provide a virtual reality experience to a vehicle seeker with a VR-enabled vehicle seeker subsystem 100 during a vehicle buying experience. A Real-World Vehicle Customer Experience (RWVCE) may include independent research by a vehicle seeker followed by an in-person visit to a vehicle dealership where the prospective vehicle seeker may view vehicles in person and discuss their purchasing decision with a representative of the dealership. However, a Virtual Reality Customer Experience (“VRCE”) of the VMSP may be configured to provide a virtual reality vehicle purchasing experience that may place the user in an immersive state during the presentation of images, 3D models, and purchasing information, which may integrate with the CarHub vehicle purchasing system. The VRCE may focus on combining the advantages of online commerce with simulating the specific events of the RWVCE, which together can have a substantial impact on the purchasing decisions of prospective vehicle buyers. While the VRCE is described with specific implementation by a VR-enabled VS subsystem, any suitable VS subsystem (e.g., with a flat display not worn by a user) may be operative to provide many of the VRCE features. The RWVCE in a physical vehicle dealership includes specific points in the purchasing process where prospective customers may form an opinion about buying a vehicle that ultimately influences their purchasing decision. The VRCE of the VMSP may be configured to abstract certain key events from the RWVCE to a virtual space and bring the experience into an online commerce buying experience, which may allow for functions that do not exist in the RWVCE.

A vehicle seeking experience in the RWVCE can generally be broken down into various steps, including (a) explore dealership, (b) choose vehicle, (c) vehicle walk around, (d) look inside vehicle, and (e) test drive the vehicle. Dealership exploration in the RWVCE may involve a customer moving through a physical dealership space, looking at possible vehicle choices or going directly to their desired vehicle choice. However, in the VRCE of the VMSP, the customer using a VR-enabled VS subsystem may be facilitated by the VMSP to open and explore a virtual space from any suitable physical location (e.g., in the comfort of the user's own home), which may allow for separate vehicles to be loaded based on user preference or populated automatically based on the buying profile of the user. Therefore, the VRCE may allow for vehicles of any make and model to be included in the virtual dealership of the VR environment, with inventory that may be pulled from the CarHub's digital inventory, which may not be limited as in a physical dealership.

Vehicle selection in the RWVCE may involve a customer physically approaching a particular vehicle of its choice or being directed to a vehicle by a real sales person. However, in the VRCE of the VMSP, different vehicles can be changed quickly without need to physically walk from one place to another. Therefore, the VRCE may allow for vehicles to be automatically filtered and presented to the user based on their CarHub profile and/or based on filtering parameters defined by the user. This can allow more vehicles to be seen and experienced in a given timespan of interaction with the VRCE as compared to in a physical-world dealership visit.

A vehicle walk around in the RWVCE may involve a customer walking around a particular vehicle in order for the customer to take in the physical presence and detail of the vehicle. However, in the VRCE of the VMSP, a customer can virtually move towards a virtual representation of a vehicle and walk around or allow that vehicle model to spin around. The relative scale of the vehicle may be changed by the VMSP so that it can be investigated from different angles easily. Therefore, the VRCE may allow for vehicles to be investigated faster than in the physical-world dealership experience.

An inside interior inspection of a vehicle in the RWVCE may involve a customer looking inside the vehicle, sitting down in the vehicle, feeling the physical space around itself, and assessing the comfort of the vehicle's interior. However, in the VRCE of the VMSP, the customer view point can be easily changed from any outside view of a vehicle to any inside view of a vehicle (e.g., to a view from the perspective of sitting in any seat or otherwise within the vehicle). The interior view may be based on 3D models or 360° panoramas, which may allow users to easily assess the spatial volume inside the vehicle and/or understand if the vehicle would be comfortable to sit in and fulfill the needs of the customer and/or its family. The VRCE of the VMSP may be operative to enable a user to quickly access and compare interior views of different vehicles to one another, for example, such that vehicle spatial characteristics can be assessed without the need to physically move from one vehicle to another.

A test drive of a vehicle in the RWVCE may involve a customer filling out liability waivers before driving a particular vehicle outside, feeling handling and performance, enjoyment of driving, and other characteristics of the vehicle in use. However, in the VRCE of the VMSP, a user can enter a virtual test drive environment representative of a particular vehicle chosen by the user, where the drive performance of the chosen vehicle can be evaluated, including the spatial representation of the user to the vehicle. Therefore, the VRCE may allow for a test drive that can be conducted at any time, without requiring a visit to a physical dealership.

The VRCE of the VMSP can be an immersive experience experienced through a virtual reality (“VR”) or augmented reality (“AR”) enabled device of a vehicle seeker subsystem that may be operative to allow partial or full immersion of a user in a virtual world. This may include the use of a head mounted display (“HMD”) that may completely fill the vision of a user as well as provide audio immersion, so that the user may be presented with a reality that removes the user from its current physical environment reality. An augmented reality device may include an HMD that partially replaces or augments part of the field of view of the user of the device. In either experience, 2D and 3D digital assets, such as image overlays, text, and 3D models, may be used to create a VR environment or serve to augment the physical world environment of the user.

As shown in FIG. 45, for example, the VRCE of the VMSP may be centered on a Virtual Showroom, which may allow users to explore and interact with virtual vehicles in an immersive environment. The Virtual Showroom may provide a familiar environment for browsing through vehicle types, and additionally may leverage all the benefits of an online vehicle commerce website experience. The VRCE may be operative to augment and to facilitate the relationship between a prospective or current customer and a dealership, by providing access to the inventory currently available at a particular dealership in proximity to a particular physical location of the user or a location defined by the user's CarHub user profile, and may allow for direct communication between the user and the dealership if desired by the user (e.g., to book a dealership visit, interact with a dealership representative via a voice only stream or a live-video stream, which may be enabled at the dealership (e.g., via a 3^{rd} party enabler subsystem) that may provide a dealership interaction portal). A Virtual Showroom may be populated by vehicles chosen by the user, or automatically populated based on results from the CarHub Car Recommendation Engine (“CRE”), which may take into account one or more various factors including, but not limited to, user preferences, driving history, Cartron results, financial status, local new and used vehicle inventories, and the like. The Virtual Showroom may be operative to allow users to experience the key events in evaluating purchase including exploration, choosing a vehicle, vehicle walk around/exterior inspection, look inside/interior inspection, and test drive. Virtual assets, such as 3D models, 360° panorama images, UI overlays, and/or the like may be used to present relevant information to the user in the immersive environment, which may enable the user to experience the physical design and size of a vehicle as in real dealership visit, but additionally the user may be provided with immediate access to information from the CarHub platform, including all information about the vehicle, such as price, loan information, efficiency, and/or the like. A user may be enabled to virtually sit inside a vehicle and look around, giving critical information about the spatial design of the vehicle and how a user might see the driving environment, how much space exists inside, and/or if it would be comfortable to drive in. While the Virtual Showroom can be experienced by one user, multiple users may enter the virtual space to discuss and collaborate on purchasing decisions. For example, a family may enter the same Virtual Showroom space in order to sit in a vehicle together and discuss the merits of the design of a vehicle for their collective needs. A Virtual Test Drive of the VMSP may be operative to provide a user with the ability to drive a vehicle through different virtual environments. The handling and performance characteristics of the vehicle may be defined by information unique to that vehicle. Therefore, the Virtual Test Drive may provide a way to assess the performance of a particular vehicle and to qualitatively compare different vehicles to one another by driving them in the same virtual environment(s).

### Description of FIG. 46

FIG. 46 is a flowchart of an illustrative process 4600 for managing a vehicle that includes at least one control module. At operation 4602, diagnostic data may be collected from the at least one control module of the vehicle. For example, any suitable subsystem of system 1 (e.g., a VO subsystem alone or in conjunction with a VDC subsystem) may be operative to collect diagnostic data from at least control module 92 of a vehicle 90 (e.g., a VO subsystem alone or in conjunction with a VDC subsystem may be operative to collect OBD data from a vehicle). At operation 4604, the health of the vehicle may be determined based on the collected diagnostic data. For example, any suitable subsystem of system 1 (e.g., a VO subsystem alone or in conjunction with VMS subsystem 10 and/or any suitable TPE subsystem) may be operative to calculate a CarScore for the vehicle based at least in part on OBD data collected from the vehicle). At operation 4606, the determined health of the vehicle may be used to facilitate at least one of maintenance of the vehicle and transfer of the ownership of the vehicle. For example, any suitable subsystem of system 1 (e.g., a VO subsystem alone or in conjunction with VMS subsystem 10 and/or any suitable TPE subsystem) may be operative to use a calculated CarScore for a vehicle to instruct an owner of the vehicle how to take care of the vehicle (e.g., to help schedule a maintenance service provider appointment) and/or how to sell the vehicle (e.g., how to properly price the vehicle for sale and/or how to present the vehicle for sale along with the CarScore number for better informing potential buyers of the vehicle).

It is understood that the operations shown in process 4600 of FIG. 46 are only illustrative and that existing operations may be modified or omitted, additional operations may be added, and the order of certain operations may be altered.

### Further Description of FIGS. 1-46

One, some, or all of the processes described with respect to FIGS. 1-46 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 and/or data structure 19 of FIG. 1 and/or memory 113 and/or data structure 119 of FIG. 1A). In other embodiments, the computer-readable medium may be a transitory computer-readable medium. In such embodiments, the transitory computer-readable medium can be distributed over network-coupled computer systems so that the computer-readable code may be stored and executed in a distributed fashion. For example, such a transitory computer-readable medium may be communicated from VMS subsystem 10 to a subsystem 100, from a subsystem 100 to VMS subsystem 10, and/or from one subsystem 100 to another subsystem 100 or vehicle 90 using any suitable communications protocol (e.g., the computer-readable medium may be communicated to a subsystem 100 via communications component 14/114 (e.g., as at least a portion of a data structure 119)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

While there have been described systems, methods, and computer-readable media for a vehicle management service, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A system for managing a vehicle comprising at least one control unit, comprising:
a user subsystem communicatively coupled to the at least one control unit and operative to collect diagnostic data from at least one control module of the vehicle; and
a service subsystem communicatively coupled to the user subsystem and operative to:
receive at least a portion of the diagnostic data from the user subsystem;
determine the health of the vehicle based on the at least a portion of the diagnostic data; and
use the determined health of the vehicle to facilitate at least one of:
maintenance of the vehicle; and
transfer of the ownership of the vehicle.

2. A method for managing a vehicle comprising:
collecting diagnostic data from at least one control module of the vehicle;
determining, using processing capabilities of an electronic system, health of the vehicle based on the collected diagnostic data; and
using the determined health of the vehicle to facilitate, using the processing capabilities of the electronic system, at least one of:
maintenance of the vehicle; and
transfer of the ownership of the vehicle.

3. The method of claim 2, wherein the diagnostic data comprises data indicative of past operation of the vehicle.

4. The method of claim 2, wherein the determined health comprises a health score that is determined based on at least one type of data of the collected diagnostic data from the following types of data:
data indicative of total mileage of the vehicle;
data indicative of mileage of the vehicle during an untreated maintenance event;
data indicative of habits of vehicle operation;
data indicative of environmental weather during vehicle operation;
data indicative of treatment of a maintenance event; and
data indicative of a collision event.

5. The method of claim 4, further comprising automatically calculating, using the processing capabilities of the electronic system, a current monetary value of the vehicle based on the health score.

6. The method of claim 4, further comprising automatically calculating, using the processing capabilities of the electronic system, a monetary value of the vehicle based on:
the health score;
sales history for vehicles of the same type as the vehicle; and
the offered sale price for currently available vehicles of the same type as the vehicle.

7. The method of claim 6, wherein the offered sale price for currently available vehicles of the same type as the vehicle comprises only the offered sale price for vehicles of the same type as the vehicle that are currently available within a particular distance of the location of the vehicle.

8. The method of claim 6, wherein the offered sale price for currently available vehicles of the same type as the vehicle comprises:
the offered sale price for vehicles of the same type as the vehicle that are currently available within a particular distance of the location of the vehicle; and
the offered sale price for vehicles of the same type as the vehicle that are currently available everywhere.

9. The method of claim 4, further comprising automatically predicting, using the processing capabilities of the electronic system, a future monetary value of the vehicle based on the health score.

10. The method of claim 9, further comprising:
collecting financial data about the current control of the vehicle; and
determining, using the processing capabilities of the electronic system, at least one re-financing option based on the collected financial data and the predicted future monetary value.

11. The method of claim 10, further comprising presenting, using a user interface output component of the electronic system, the at least one re-financing option to a user of the vehicle.

12. The method of claim 9, further comprising:
collecting financial data about the current control of the vehicle; and
determining, using the processing capabilities of the electronic system, that it is a good time to sell the vehicle based on the collected financial data and the predicted future monetary value.

13. The method of claim 9, further comprising:
collecting financial data about the current control of the vehicle; and
determining, using the processing capabilities of the electronic system, that it is a good time to sell the vehicle based on:
the collected financial data;
the predicted future monetary value;
sales history for vehicles of the same type as the vehicle; and
the offered sale price for currently available vehicles of the same type as the vehicle.

14. The method of claim 13, wherein the offered sale price for currently available vehicles of the same type as the vehicle comprises only the offered sale price for vehicles of the same type as the vehicle that are currently available within a particular distance of the location of the vehicle.

15. The method of claim 13, wherein the offered sale price for currently available vehicles of the same type as the vehicle comprises:
the offered sale price for vehicles of the same type as the vehicle that are currently available within a particular distance of the location of the vehicle; and
the offered sale price for vehicles of the same type as the vehicle that are currently available everywhere.

16. The method of claim 4, further comprising presenting, using a user interface output component of the electronic system, an offer for sale of the vehicle, wherein the offer includes the health score.

17. The method of claim 4, wherein:
the health score comprises a driver score associated with operation of the vehicle by a particular user; and
the method further comprises:
obtaining answers to questions of a questionnaire from the user; and
determining, using the processing capabilities of the electronic system, a type of vehicle that fulfills the needs of the user based on the driver score and the obtained answers.

18. The method of claim 17, wherein the answers are directed to:
vehicle brand perception of the user;
personality of the user;
personal values of the user; and
vehicle specification preference of the user.

19. The method of claim 2, wherein the determined health comprises a health score that is determined based on at least two types of data of the collected diagnostic data from the following types of data:
data indicative of total mileage of the vehicle;
data indicative of mileage of the vehicle during an untreated maintenance event;
data indicative of habits of vehicle operation;
data indicative of environmental weather during vehicle operation;
data indicative of treatment of a maintenance event; and
data indicative of a collision event.

20. A non-transitory computer-readable storage medium storing at least one program, the at least one program comprising instructions, which when executed by an electronic device, cause the electronic device to:
collect diagnostic data from at least one control module of a vehicle;
determine the health of the vehicle based on the collected diagnostic data; and
use the determined health of the vehicle to facilitate at least one of:
maintenance of the vehicle; and
transfer of the ownership of the vehicle.
